(19) United States
(12) Patent Application Publication
(10) Pub. No.: US 2019/0094150 A1
(43) Pub. Date: Mar. 28, 2019

(54) METHOD FOR MENDING METALLIC PLATE AND METHOD FOR MANUFACTURING MOLD

(71) Applicant: Mitsubishi Chemical Corporation, Chiyoda-ku, Tokyo (JP)

(72) Inventors: Hiroshi OBATA, Tokyo (JP); Junichi NAGASE, Tokyo (JP); Tooru KAJIWARA, Tokyo (JP); Kei ISHIHARA, Tokyo (JP)

(73) Assignee: Mitsubishi Chemical Corporation, Chiyoda-ku, Tokyo (JP)

(21) Appl. No.: 15/527,276

(22) PCT Filed: Nov. 17, 2015
(86) PCT No.: PCT/JP2015/082289

§ 371 Date: May 16, 2017

(30) Foreign Application Priority Data
Nov. 18, 2014 (JP) 2014-233272

(51) Int. Cl. G01N 21/88; G01N 21/892; G01B 11/30

(52) U.S. Cl. CPC G01N 21/8806; G01N 21/892; G01N 2021/8925; G01N 2021/8924; G01B 11/30

(57) ABSTRACT

The present invention provides a method for mending projection and recess defects existing on the surface of a metallic plate, wherein steps (1) to (2) are repeated until it is determined in step (1) that mending of the projection and recess defects on the surface of the metallic plate is no longer necessary. Step (1): A step for shining light onto the surface of the metallic plate, detecting the positions of projection and recess defects on the surface of the metallic plate according to the brightness distribution on the metallic plate, the brightness distribution being obtained from reflected light, quantifying the brightness intensities of the projection and recess defects, and determining whether it is necessary to mend the projection and recess defects. Step (2): A step for mending the projection and recess defects for which it is determined in step (1) that mending is necessary.

### TECHNICAL FIELD

The present invention relates to a method for repairing a metal plate. More particularly, the invention relates to a metal plate repairing method for repairing an irregular defect on a surface of the metal plate generated in a manufacturing process, a processing process, and a utilization process for the metal plate.

This application is based upon and claims the benefit of priority from the prior Japanese Patent Applications No. 2014-233272, filed on Nov. 18, 2014, the entire content of which is incorporated herein.

### BACKGROUND ART

A metal plate such as a stainless steel plate is excellent in weather resistance, corrosion resistance and surface appearance, and thus is used for various products. An irregular defect may be generated in a manufacturing process, a processing process, and a utilization process for a metal plate such as a stainless steel plate. For example, the metal plate may be used as a mold for manufacturing a resin molded body. When an irregular defect is present on a surface of the mold, the irregular defect is transferred to the resin molded body, and thus there is a shortcoming in that an irregular defect is generated on a surface of the obtained resin molded body.

In order to solve this shortcoming, the irregular defect of the metal plate needs to be repaired, and there is a need to discover a part of the metal plate in which the irregular defect is present and an extent of a height or a depth of the irregular defect.

For example, Patent Literature 1 proposes an inspection method in which slit light is incident on a surface of a test object, reflected light from the surface of the test object is projected onto a screen, a reflected projection image projected on the screen is photographed by a CCD camera, and a defect side is determined from image data.

### CITATION LIST

### Patent Literature

Patent Literature 1: JP 5-99639 A

### SUMMARY OF THE INVENTION

Problem to be Solved by the Invention

In the method disclosed in Patent Literature 1, only information about a position at which an irregular defect is present may be obtained, and information related to a height or a depth of the irregular defect may not be obtained. Therefore, in the case of repairing the metal plate using an inspection result described in Patent Literature 1, since quantitative information related to the amount of repair of the irregular defect is not obtained, an extent of repair has depended on experience and feeling of a person who repairs the metal plate. As a result, when a person having little experience repairs the metal plate, there is a problem that the irregular defect is excessively corrected to cause a defect that cannot be repaired, or the repair amount is insufficient, and a repair operation (an operation including from correction to inspection) is repeated more frequently than necessary.

In addition, when the metal plate is used as a mold for manufacturing a resin molded body, whether an irregular defect of the metal plate could be repaired could not be verified unless the resin molded body molded using the metal plate after repair was inspected.

An object of the invention is to solve these problems. In other words, an object of the invention is to provide a method for repairing an irregular defect (with an appropriate repair amount) irrespective of the presence or absence of experience. In addition, an object of the invention is to provide a method for accurately repairing an irregular defect without verification through a resin molded body and a method for manufacturing a mold including a repair process when a metal plate is used as the mold.

### Means for Solving Problem

The above problems are solved by items [1] to [21] of the invention.

[1] A method for repairing an irregular defect present on a surface of a metal plate (hereinafter referred to as “the irregular defect of the metal plate”), wherein processes (1) and (2) are repeated until it is determined that repair of the irregular defect on the surface of the metal plate is unnecessary in the process (1):

process (1): process of determining whether repair of the irregular defect is necessary by letting light into the surface of the metal plate, detecting a position of the irregular defect on the surface of the metal plate using a brightness distribution of the metal plate obtained from reflected light, and quantifying intensity of brightness of the irregular defect,

process (2): process of repairing the irregular defect determined to require repair in the process (1).

[2] The method for repairing the metal plate according to [1], wherein the brightness distribution of the metal plate is obtained by converting a brightness distribution of a reflected image or a brightness distribution of a reflected projection image obtained in detection method 1 below:

<Detection Method 1>

light is incident on a region including the irregular defect present on the surface of the metal plate and a normal part around the irregular defect from a light source, a reflected image or a reflected projection image of reflected light reflected on the surface of the metal plate is photographed, brightness of the obtained image of the metal plate is measured, and a brightness distribution of the obtained reflected image or a brightness distribution of the obtained reflected projection image is converted into the brightness distribution of the metal plate.

[3] The method for repairing the metal plate according to [1] or [2], wherein light is incident on the surface of the metal plate from at least two directions in the process (1).

[4] The method for repairing the metal plate according to any one of [1] to [3], wherein an angle at which light is incident on the surface of the metal plate is in a range of 20° to 70°.

[5] The method for repairing the metal plate according to any one of [1] to [4], wherein a part determined to require repair of the irregular defect in the process (1) is a part indicating a peak satisfying at least one of conditions (i) and (ii) below among peaks of the brightness distribution of the metal plate:

(i) a height or a depth of a peak of the brightness distribution is greater than or equal to a predetermined value a,

(ii) a width of a peak at a brightness value, at which a difference between an average value of brightness values of a normal part and a brightness value of a peak of a brightness distribution of an irregular defect portion is a predetermined value b, is greater than or equal to a predetermined value c.

[6] The method for repairing the metal plate according to any one of [2] to [4], wherein a part determined to require repair of the irregular defect in the process (1) is a part indicating a peak satisfying at least one of conditions (i′) and (ii) below among peaks of the brightness distribution of the metal plate:

(i′) Michelson contrast (MC) calculated by Equation (1) below is greater than or equal to a predetermined value d,

MC=(Lmax−Lmin)/(Lmax+Lmin) (1)

(In the case of a concave defect, Lmax represents a maximum brightness value of a convex peak, and Lmin represents an average value of brightness values of the normal part. In the case of a convex defect, Lmax represents an average value of brightness values of the normal part, and Lmin represents a minimum brightness value of a concave peak.)

(ii) a width of a peak at a brightness value, at which a difference between an average value of brightness values of a normal part and a brightness value of a peak of a brightness distribution of an irregular defect portion is a predetermined value b, is greater than or equal to a predetermined value c.

[7] The method for repairing the metal plate according to [5], wherein the part determined to require repair of the irregular defect is detected by converting the brightness distribution of the metal plate into an angle change rate distribution of the metal plate, and

replacing a peak in the obtained angle change rate distribution of the metal plate with the peak of the brightness distribution of the metal plate in the process (1).

[8] The method for repairing the metal plate according to [5], wherein the part determined to require repair of the irregular defect is detected by converting the brightness distribution of the metal plate into an angle change rate distribution of the metal plate, converting the angle change rate distribution of the metal plate into a height distribution of a shape of the metal plate, and

replacing a peak in the obtained height distribution of the shape of the metal plate with the peak of the brightness distribution of the metal plate in the process (1).

[9] The method for repairing the metal plate according to [5], wherein the metal plate is a mold for molding a resin molded body, and the part determined to require repair of the irregular defect is detected by converting the brightness distribution of the metal plate into an angle change rate distribution of the metal plate, inverting and converting the angle change rate distribution of the metal plate into an angle change rate distribution of a virtual resin molded body, and

replacing a peak in the obtained angle change rate distribution of the virtual resin molded body with the peak of the brightness distribution of the metal plate in the process (1).

[10] The method for repairing the metal plate according to [5], wherein the metal plate is a mold for molding a resin molded body, and the part determined to require repair of the irregular defect is detected by converting the brightness distribution of the metal plate into an angle change rate distribution of the metal plate, inverting and converting the angle change rate distribution of the metal plate into an angle change rate distribution of a virtual resin molded body, converting the angle change rate distribution of the virtual resin molded body into a brightness distribution of the virtual resin molded body, and

replacing a peak in the obtained brightness distribution of the virtual resin molded body with the peak of the brightness distribution of the metal plate in the process (1).

[11] The method for repairing the metal plate according to [6], wherein the metal plate is a mold for molding a resin molded body, and a part determined to require repair of the irregular defect is detected by inverting and converting an angle change rate distribution of the metal plate obtained from the brightness distribution of the metal plate into an angle change rate distribution of a virtual resin molded body, converting the angle change rate distribution of the virtual resin molded body into a brightness distribution of the virtual resin molded body, and

replacing a peak in the obtained brightness distribution of the virtual resin molded body with a peak of the brightness distribution of the metal plate in the process (1).

[12] The method for repairing the metal plate according to [5], wherein the metal plate is a mold for molding a resin molded body, and the part determined to require repair of the irregular defect is detected by converting the brightness distribution of the metal plate into an angle change rate distribution of the metal plate, converting the angle change rate distribution of the metal plate into a height distribution of a shape of the metal plate, inverting and converting the obtained height distribution of the shape of the metal plate into a height distribution of a shape of a virtual resin molded body, and

replacing a peak in the obtained height distribution of the shape of the virtual resin molded body with the peak of the brightness distribution of the metal plate in the process (1).

[13] The method for repairing the metal plate according to any one of [1] to [12], wherein further repair is determined to be unnecessary when the part determined to require repair of the irregular defect is not detected

in a process of determining whether repair of the irregular defect of the metal plate is necessary in the process (1).

[14] The method for repairing the metal plate according to [5], wherein a value obtained by converting the height or the depth of the peak of the brightness distribution of the metal plate described in the condition (i) of [5] into shape data is set to shape data X, a value obtained by converting the predetermined value a into shape data is set to shape data Y, and a required repair amount of the repair is set to |X−Y| or more and |X| or less.

[15] The method for repairing the metal plate according to [14], wherein the required repair amount of the repair is set to |X−Y| or more and |X| or less by replacing the brightness distribution of the metal plate with any one of the angle change rate distribution of the metal plate according to [7], the height distribution of the shape of the metal plate according to [8], the angle change rate distribution of the virtual resin molded body according to [9], the brightness distribution of the virtual resin molded body according to [10], or the height distribution of the shape of the virtual resin molded body according to [12].

[16] The method for repairing the metal plate according to [6],

wherein a value obtained by converting a value of Michelson contrast (MC) of a peak of the brightness distribution of the metal plate described in the condition (i′) of [6] into shape data is set to shape data X,

a value obtained by converting the predetermined value d into shape data is set to shape data Y, and

a required repair amount of the repair is set to |X−Y| or more and |X| or less.

[17] The method for repairing the metal plate according to [16], wherein the brightness distribution of the metal plate is replaced with the brightness distribution of the virtual resin molded body according to [11], and the required repair amount of the repair is set to |X−Y| or more and |X| or less.

[18] The method for repairing the metal plate according to [5], wherein at the peak of the brightness distribution of the metal plate described in the condition (ii) of [5] or the condition (ii) of [6], the width of the peak at the brightness value, at which the difference between the average value of the brightness values of the normal part and the brightness value of the peak of the brightness distribution of the irregular defect portion is the predetermined value b, is set to V, the predetermined value c is set to W, and a required repair amount of the repair is set to |V−W| or more and |V| or less.

[19] The method for repairing the metal plate according to [18], wherein the required repair amount of the repair is set to |V−W| or more and |V| or less by replacing the brightness distribution of the metal plate with any one of the angle change rate distribution of the metal plate according to [7], the height distribution of the shape of the metal plate according to [8], the angle change rate distribution of the virtual resin molded body according to [9], the brightness distribution of the virtual resin molded body according to [10], or the height distribution of the shape of the virtual resin molded body according to [12].

[20] The method for repairing the metal plate according to any one of [1] to [19], wherein the process (2) includes repairing using at least one of plastic working and grinding.

[21] A method for manufacturing a mold having a process including the method for repairing the metal plate according to any one of [1] to [20].

### Effect of the Invention

According to a method for repairing a metal plate of the invention, it is possible to quantify the amount of repair of an irregular defect on a surface of the metal plate, and to repair the irregular defect with an appropriate repair amount irrespective of experience of a repair person. In addition, according to a method for repairing a metal plate of the invention, it is possible to accurately repair an irregular defect on a surface of the metal plate without verification through an obtained resin molded body when the metal plate is used as a mold for manufacturing the resin molded body.

### BRIEF DESCRIPTION OF DRAWINGS

FIG. 1 is a schematic view of a region including an irregular defect and a normal part around the irregular defect;

FIG. 2 is a schematic view in which a portion other than a preset region (inside a dotted line) is masked with a film;

FIG. 3 is a diagram illustrating arrangement of respective devices for obtaining a brightness distribution of a reflected projection image;

FIG. 4A is a schematic view of a reflected projection image obtained by projecting reflected light reflected from a surface of a metal plate on a screen;

FIG. 4B is a schematic view of a digital image of a reflected projection image on line 3 (a line joining point 3 on a line ZY21-ZY22 and point 3 on a line ZY11-ZY12) of FIG. 4A;

FIG. 5 is a graph illustrating a brightness distribution of line 3 of FIG. 4A in a Z direction;

FIG. 6 is a schematic view illustrating an optical path length from a light source to the screen;

FIG. 7A is a schematic view in which a grid-shaped square is provided using black ink on a surface of a metal plate at intervals of 25 mm with respect to a region of 200 mm square in which a center of a convex defect is set as an origin;

FIG. 7B is a schematic view in which a grid-shaped square is provided using black ink on a surface of a metal plate at intervals of 25 mm with respect to a region of 200 mm square in which a center of a concave defect is set as an origin;

FIG. 8A is a schematic view of a reflected projection image obtained when light is incident on the metal plate of FIG. 7A from a light source, and reflected light reflected from a surface of the metal plate is projected on the screen;

FIG. 8B is a schematic view of a reflected projection image obtained when light is incident on the metal plate of FIG. 7B from the light source, and reflected light reflected from a surface of the metal plate is projected on the screen;

FIG. 9 is a graph illustrating a calibration curve (1) used to convert a brightness distribution of a reflected projection image into a brightness distribution of a metal plate;

FIG. 10 is a graph illustrating a brightness distribution of a reflected projection image when a concave defect and a convex defect are present in a preset region;

FIG. 11 is a graph illustrating the brightness distribution of the metal plate converted from the brightness distribution of the reflected projection image (FIG. 10);

FIG. 12 is a diagram illustrating a height or depth p(h) of a peak and a width p(w) of a peak in the brightness distribution of the metal plate in the graph illustrated in FIG. 11;

FIG. 13 is a graph illustrating a brightness distribution of a metal plate when a plurality of concave defects is present in a preset region;

FIG. 14 is a graph illustrating a brightness distribution of a metal plate when a plurality of convex defects is present in a preset region;

FIG. 15 is a graph illustrating a curve f(x) of a convex defect obtained by measuring a surface of a metal plate of a model using a laser displacement meter;

FIG. 16 is a graph illustrating a curve plotted by setting a horizontal axis to a position x, and a vertical axis to an angle f(x);

FIG. 17 is a graph illustrating a curve plotted by setting a horizontal axis to a position x, and a vertical axis to an angle change rate r(x);

FIG. 18 is a graph illustrating a brightness distribution of a metal plate of a model;

FIG. 19 is a graph illustrating a calibration curve (2) used to convert an angle change rate distribution of a metal plate into a brightness distribution of the metal plate;

FIG. 20 is a graph illustrating the angle change rate distribution of the metal plate converted from the brightness distribution of the metal plate (FIG. 12);

FIG. 21 is a graph illustrating a height distribution of a shape of a metal plate converted from the angle change rate distribution of the metal plate (FIG. 20);

FIG. 22 is a graph illustrating an angle change rate distribution of a virtual resin molded body converted from the brightness distribution of the metal plate (FIG. 12);

FIG. 23 is a graph illustrating an angle change rate distribution of a virtual resin molded body obtained by inverting the angle change rate distribution of the metal plate (FIG. 20);

FIG. 24 is a graph illustrating an angle change rate distribution of a resin molded body of a model;

FIG. 25 is a diagram illustrating arrangement of respective devices for obtaining a brightness distribution of a transmitted projection image;

FIG. 26 is a graph illustrating a brightness distribution of the resin molded body of the model;

FIG. 27 is a graph illustrating a calibration curve (3) used to convert an angle change rate distribution of the resin molded body of the model into a brightness distribution of the resin molded body of the model;

FIG. 28 is a graph illustrating a brightness distribution of a virtual resin molded body converted from the angle change rate distribution of the virtual resin molded body (FIG. 23);

FIG. 29 is a graph illustrating a height distribution of a shape of a virtual resin molded body obtained by inverting the height distribution of the shape of the metal plate (FIG. 21);

FIG. 30 is a graph illustrating a height distribution (solid line) of a shape before repair of an irregular defect portion and a height distribution (dotted line) of a shape after repair; and

FIG. 31 is a graph illustrating an angle change rate distribution (solid line) before repair of an irregular defect portion and an angle change rate distribution (dotted line) after repair.

### MODE(S) FOR CARRYING OUT THE INVENTION

A detailed description will be given of a preferred embodiment of a method for repairing a metal plate of the invention.

The invention relates to a method for repairing an irregular defect present on a surface of the metal plate, and a method for repairing the metal plate in which process (1) to process (2) below are repeated until it is determined that repair of the irregular defect on the surface of the metal plate is unnecessary in process (1) below.

<Process (1)>

Process (1) is a process including detecting a position of the irregular defect present on the surface of the metal plate using a brightness distribution of the metal plate obtained from reflected light after light is incident on the surface of the metal plate, and determining whether the irregular defect needs to be repaired by quantifying intensity of brightness of the irregular defect.

Specifically, the brightness distribution of the metal plate refers to a brightness distribution obtained by converting a brightness distribution of a reflected image or a brightness distribution of a reflected projection image obtained from a region including the irregular defect and a normal part around the irregular defect on the surface of the metal plate in detection method 1 described below, and represents an irregular state of the surface of the metal plate.

Specifically, examples of a method for determining whether the irregular defect on the surface of the metal plate needs to be repaired include a method for determining a part indicating a peak which satisfies a condition described in any one of (Method A) to (Method F) described below among peaks of the brightness distribution of the metal plate to be a part in which the irregular defect needs to be repaired when the part is detected, and determining that further repair is unnecessary when the part indicating the peak which satisfies the condition is not detected.

<Process (2)>

Process (2) is a process of repairing the irregular defect determined to require repair in process (1). The repair part of the irregular defect determined in process (1) may be repaired by plastic working or grinding described below.

<Metal Plate>

Examples of a material of the metal plate include stainless steel. Examples of a form of the metal plate include a band plate and a standard size plate. Referring to a surface state of the metal plate, a value of surface roughness Ra in accordance with ISO 4287 is preferably 1 μm or less. When the surface roughness Ra is 1 μm or less, light may be efficiently reflected when light is incident on the metal plate. An upper limit of the surface roughness Ra is more preferably 0.1 μm or less.

<Irregular Defect and Normal Part>

Even though the surface of the metal plate is a flat surface macroscopically, the surface has minute irregularity microscopically. In the brightness distribution originating from the minute irregularity or a distribution derived from the brightness distribution, irregularity in which peak intensity is greater than or equal to a threshold value described below, that is, irregularity in which a depth or a height of the irregularity is greater than or equal to a certain threshold value is referred to as an irregular defect, and the threshold value is determined based on a purpose and use of the metal plate. The normal part is a part other than the irregular defect, and refers to a region in which a degree of the peak intensity or a change in peak intensity is less than a threshold value in the brightness distribution or the distribution derived from the brightness distribution.

<Region Including Irregular Defect on Surface of Metal Plate and Normal Part Around the Irregular Defect>

A region including at least a portion of the irregular defect is set as the region including the irregular defect of the metal plate and the normal part around the irregular defect. When the irregular defect, for example, a length thereof exceeds 200 mm, at least a portion of the irregular defect may be set to be included in the region. However, when the length is small and less than 200 mm, the whole irregular defect is preferably set to be included in the region.

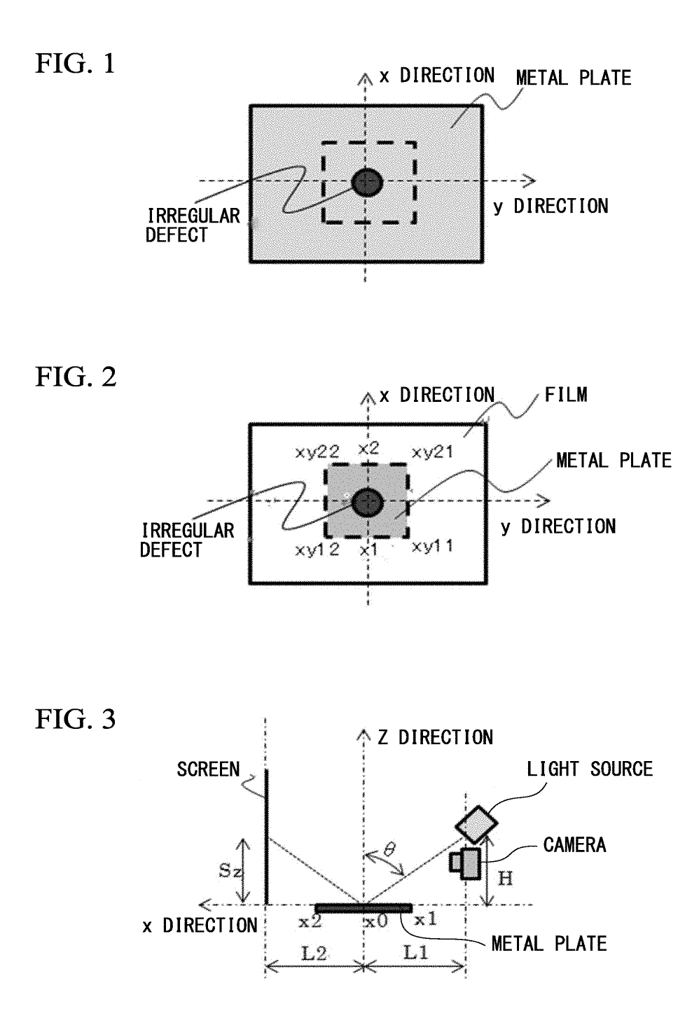

For example, as illustrated in FIG. 1, when the irregular defect has a size of 100 mm in diameter, a region of at least 200 mm square including the normal part is set. In the region including the irregular defect and the normal part around the irregular defect, it is preferable to place a mark on the surface of the metal plate so that a preset region (region surrounded by a broken line of FIG. 1) is recognized Examples of a method for placing a mark on the surface of the metal plate include a method for pasting a film, from which a region surrounded by a point xy11, a point xy12, a point xy22, and a point xy21 of the film is cut out in a rectangular shape such that the region including the irregular defect and the normal part around the irregular defect is exposed, on a metal surface as illustrated in FIG. 2.

<Method for Converting Irregular State of Metal Plate into Brightness Distribution of Metal Plate (Detection Method 1)>

In process (1), light is incident on a region including the irregular defect of the metal plate from a light source, reflected light reflected from the surface of the metal plate is photographed as a reflected image using a camera or reflected light reflected from the surface of the metal plate is projected on a screen and a reflected projection image projected on the screen is photographed using the camera, brightness of the obtained image is measured to obtain brightness distribution of the reflected image or the reflected projection image, and the brightness distribution of the reflected projection image is converted into the brightness distribution of the metal plate. In this way, the irregular state of the metal plate may be converted into the brightness distribution of the metal plate.

A detailed description will be given of a case in which the reflected projection image reflected from the surface of the metal plate and projected on the screen is photographed with reference to FIG. 3.

The light source is disposed at a position away from a central portion x0 of the defect of the metal plate by a length L1 in a negative direction of an x axis and by a height H in a z axis. The screen is vertically disposed at a position away from the central portion x0 of the defect of the metal plate by a length L2 in a positive direction of the x axis.

Light emitted from the light source is incident on the metal plate at an incidence angle θ. Light reflected from the metal plate forms an image on the screen, and the reflected projection image of the region including the irregular defect and the normal part around the irregular defect is projected as a monochrome grayscale image at a position away from a position of the central portion x0 of the defect of the metal plate by a height Sz in a Z direction on the screen.

The monochrome grayscale image projected on the screen is photographed using the camera to obtain the brightness distribution.

From the viewpoint of efficient utilization of light from the light source, the length L1 is preferably a short distance within a range in which the light source can be installed, the length L2 is preferably a short distance within a range in which the screen can be installed, and the height H is preferably a height at which the angle θ is in a range of 20 to 70°. Specifically, when an evaluation region of the metal plate is 5 cm to 2.0 m in width and 5 cm to 2.0 m in depth, the length L1 may be set to 30 cm to 10 m, the length L2 may be set to 20 cm to 10 m, and the height H may be set to 20 cm to 10 m. In this instance, a size of the screen may be set to 20 cm to 10 m in height and 20 cm to 10 m in width.

The camera is preferably installed at a position at which the entire reflected projection image projected on the screen may be photographed.

Visibility of the reflected projection image projected on the screen may vary depending on a direction of incidence of light. Thus, it is preferable to use brightness distributions of a plurality of reflected projection images measured by allowing light to incident on the surface of the metal plate from at least two directions. The irregular defect may be more stereoscopically discovered using the brightness distributions of the plurality of reflected projection images measured by allowing light to incident on the surface of the metal plate from at least two directions.

In addition to the method for photographing the reflected projection image projected on the screen, the brightness distribution may be obtained from the reflected image using a similar method to that described above after reflected light reflected from the surface of the metal plate is photographed using the camera to obtain the reflected image.

<Light Source>

A point light source is preferable as a type of light source in that the reflected projection image projected on the screen is clear. Examples of a lamp used as light source include a metal halide lamp, a halogen lamp, and a high-pressure mercury lamp. A wavelength of light is preferably in a range of 280 to 380 nm (ultraviolet region) and in a range of 380 to 780 nm (visible light region).

<Screen>

Examples of the screen include a mat-based screen, a bead-based screen and a pearl-based screen. Examples of color of the screen include white and gray. From the viewpoint of efficient repairing, a size of the screen is preferably equal to or larger than a size that includes the entire reflected projection image projected on the screen. In this instance, the reflection projection image projected on the screen corresponds to a reflected projection image of the whole region including the irregular defect and the normal part around the irregular defect of the metal plate.

<Camera>

The camera may be an analog camera or a digital camera. However, the digital camera is preferable from the viewpoint of digital analysis. When an image is photographed using the analog camera, an obtained image is converted into a digital image and analyzed.

Examples of a size of the digital include 800×600, 1024×768, 1600×1200, 2048×1536 or 5472×3648 when the size is represented by the number of pixels in a horizontal direction and a vertical direction. However, the size is not limited thereto.

Photographing using the camera is preferably performed under light shielding. When photographing using the camera is performed under light shielding, a high-accuracy brightness distribution may be obtained. Examples of a method for setting a light shielding state include a method for blinding a window to place an entire room in a light shielding state when the window is present under a photographic environment. In addition, it is preferable to prevent reflected light, which is reflected from a region other than the region including the irregular defect and the normal part around the irregular defect of the metal plate, from being reflected on the screen.

A photographing mode of the camera may be a color image mode or a monochrome image mode. When photographing is performed in the color image mode, it is preferable to perform conversion into a monochrome image using image processing software.

Brightness of an end portion of the image may be lower than brightness of a central portion thereof due to an influence of a lens of the camera. In such a case, it is preferable to perform correction use image processing software so that brightness of the whole image becomes uniform.

<Brightness Distribution of Reflected Image or Reflected Projection Image>

The brightness distribution of the reflected image or the reflected projection image may be obtained by extracting a plurality of lines from the region including the irregular defect and the normal part around the irregular defect on a digital image using image processing software, and obtaining brightness values for all pixels present in the respective lines.

An example of a method for obtaining the brightness distribution of the reflected projection image will be described below. The method below is not limited to the case of obtaining the brightness distribution of the reflected projection image, and may be applied to the case of obtaining the brightness distribution of the reflected image.

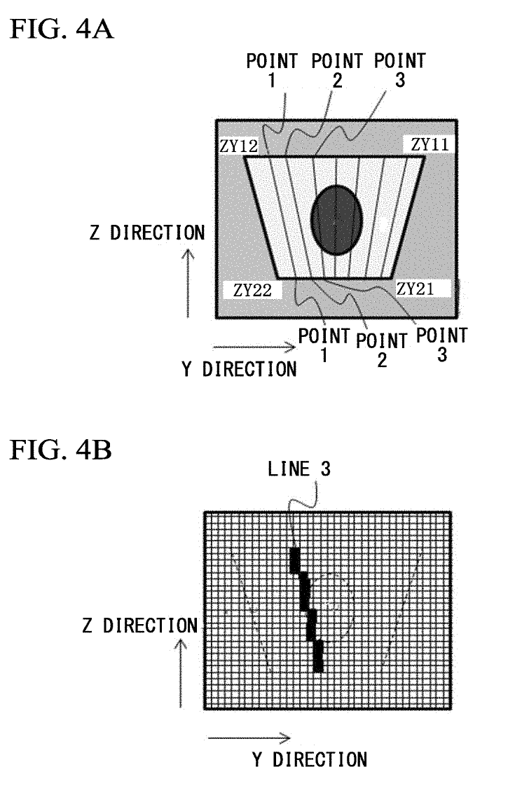

FIG. 4A is the reflected projection image obtained when light is incident on the surface of the metal plate from the light source, and reflected light reflected from the surface of the metal plate is projected on the screen in arrangement illustrated in FIG. 3. Respective points ZY11, ZY12, ZY21 and ZY22 of FIG. 4A correspond to a reflected projection image of the points xy11, xy12, xy21 and xy22 of FIG. 2.

A side joining a point ZY11 and a point ZY12 is defined as an upper side, a side joining a point ZY22 and a point ZY21 is defined as a lower side, and each of the upper side and the lower side is divided in a Y direction into N equal parts, thereby obtaining a point 1 (upper side), a point 2 (upper side), . . . , a point N-1 (upper side) and a point 1 (lower side), a point 2 (lower side), . . . , a point N-1 (lower side). N-1 lines are extracted by joining the point 1 (upper side) and the point 1 (lower side), the point 2 (upper side) and the point 2 (lower side), . . . , and the point N-1 (upper side) and the point N-1 (lower side).

N may be appropriately selected from 2 to 10,000 according to a size of the irregular defect. For example, in the case of a defect of 100 mm, N may be selected so that a line pitch is about 1 to 20 mm Brightness distributions are obtained for all N-1 lines.

FIG. 4A is an example in the case of N=8. FIG. 4B is a digital image of a reflected projection image on line 3 (a line joining point 3 on a line ZY21-ZY22 and point 3 on a line ZY11-ZY12) of FIG. 4A. Brightness values are obtained for all pixels present on line 3. A brightness value is a gray level of a monochrome image, and may be represented by, for example, 128 gradation levels, 256 gradation levels, 512 gradation levels or 1,024 gradation levels.

FIG. 5 represents a brightness distribution of line 3 in the Z direction. In FIG. 5, a horizontal axis represents the Z direction, and a vertical axis represents a brightness value.

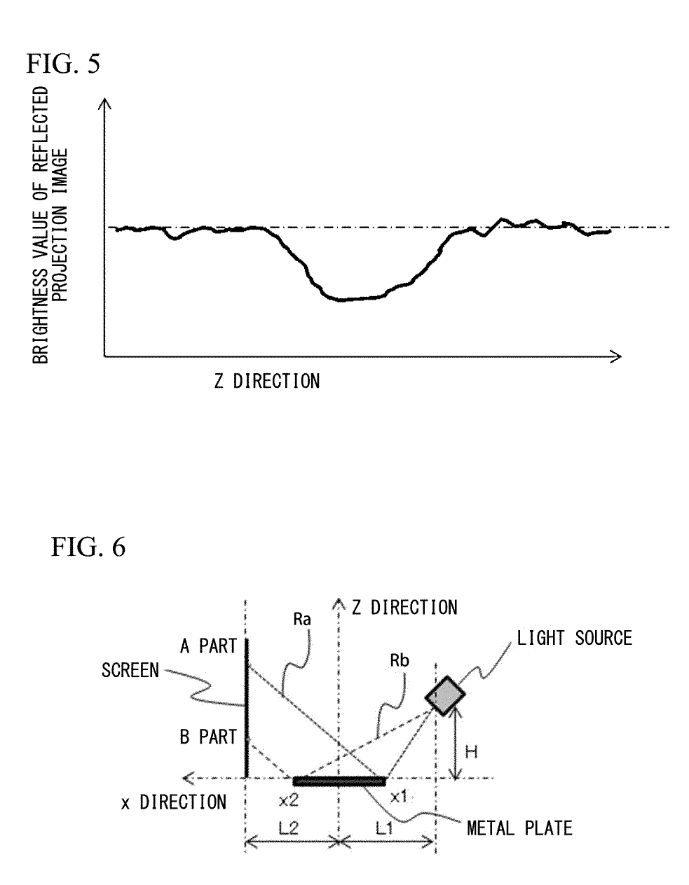

Brightness unevenness due to an optical path length occurs in the reflected projection image. For example, when a metal plate having no irregular defect is used, an optical path length of reflected light “Ra” of FIG. 6 is longer than an optical path length of reflected light Rb, and thus a brightness value of a part A of the reflected projection image is smaller than a brightness value of a part B thereof. When a difference between the brightness value of the part A and the brightness value of the part B is large, the brightness unevenness may be corrected using a light attenuation rule (intensity of attenuated light of light is inversely proportional to the square of a distance from the light source). For example, in the case of 256 gradation levels, when a difference between the brightness value of part A and the brightness value of part B is 5 or more, it is preferable to correct the above-described brightness unevenness.

<Brightness Distribution of Metal Plate>

The brightness distribution (a brightness curve in which a horizontal axis represents a position x and a vertical axis represents brightness) of the metal plate is obtained by converting a position Z of the brightness distribution (a brightness curve in which a horizontal axis represents the position Z and a vertical axis represents brightness) of the reflected image or the reflected projection image.

An example of a conversion method will be described below.

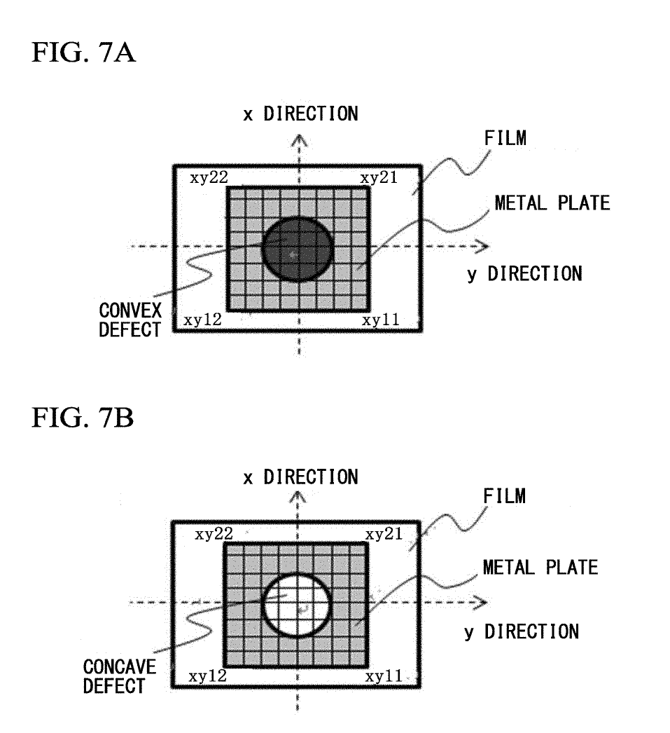

In FIG. 7A, a metal plate having a convex defect of a known shape is used to provide a grid-shaped square on a surface of the metal plate using black ink at intervals of 25 mm with respect to a region of 200 mm×200 mm in which a center of the convex defect is set as an origin. Here, an arbitrary direction on the surface of the metal plate is set to an x coordinate.

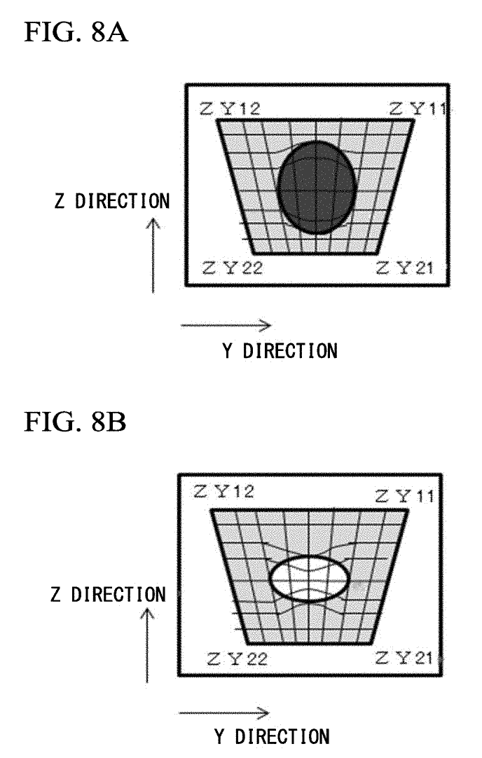

FIG. 8A is a reflected projection image obtained when light from the light source is incident on this metal plate, and reflected light reflected from the surface of the metal plate is projected on the screen. A Z direction corresponds to an x direction of FIG. 7A, and a Y direction corresponds to a y direction of FIG. 7A. As illustrated in FIG. 8A, when a defect is a convex defect, the defect is magnified and projected in the Z direction. An image obtained by reflecting and projecting an x coordinate is set to a Z coordinate.

In FIG. 7B, a metal plate having a concave defect of a known shape is used to provide a grid-shaped square on a surface of the metal plate using black ink at intervals of 25 mm with respect to a region of 200 mm×200 mm in which a center of the concave defect is set as an origin. Here, similarly to FIG. 7A, an arbitrary direction on the surface of the metal plate is set to an x coordinate.

FIG. 8B is a reflected projection image obtained when light from the light source is incident on this metal plate, and reflected light reflected from the surface of the metal plate is projected on the screen. A Z direction corresponds to an x direction of FIG. 7B, and a Y direction corresponds to a y direction of FIG. 7B. As illustrated in FIG. 8B, when a defect is a concave defect, the defect is reduced and projected in the Z direction. An image obtained by reflecting and projecting an x coordinate is set to a Z coordinate.

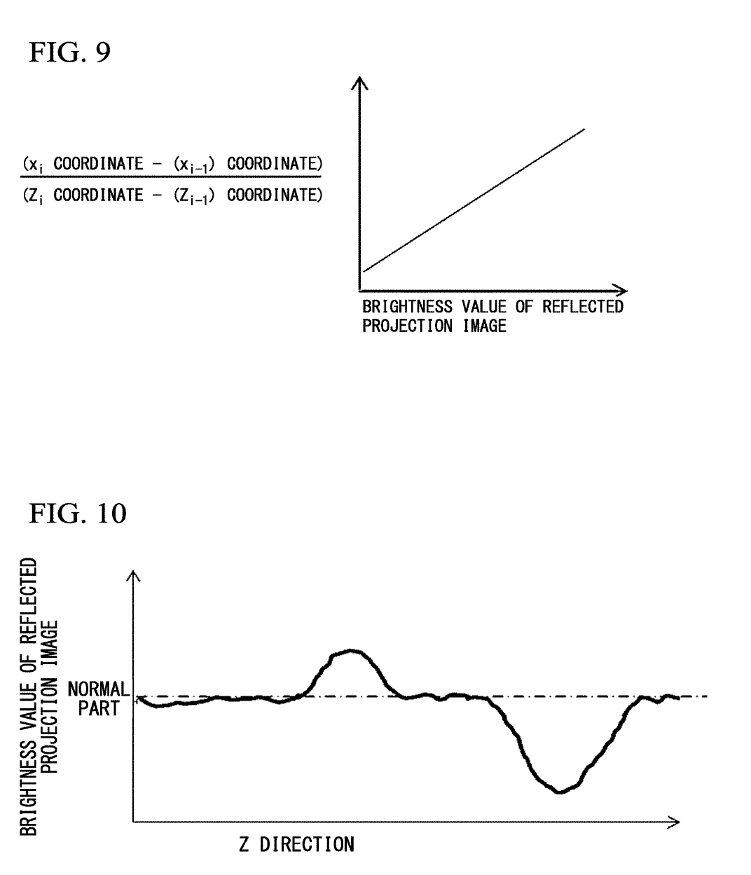

Here, for each lattice point in the defect of the metal plate, a value of xᵢ coordinate−(xᵢ₋₁) coordinate is obtained with regard to a lattice point (i) present in the xᵢ coordinate and a lattice point (i−1) present in the (xᵢ₋₁) coordinate adjacent thereto. Subsequently, a value of Z₁ coordinate−(Zᵢ₋₁) coordinate and a brightness value in the reflected projection image are obtained with regard to a lattice point of the reflected projection image corresponding to each of the lattice point (i) and the lattice point (i−1). A graph of a calibration curve (1) of FIG. 9 is created using (xᵢ coordinate−(xᵢ₋₁) coordinate)/(Zᵢ coordinate−(Zᵢ₋₁) coordinate) and a brightness value of each lattice point.

The brightness distribution (the brightness curve in which the horizontal axis represents the position x and the vertical axis represents brightness) of the metal plate may be obtained by converting the position Z of the brightness distribution (the brightness curve in which the horizontal axis represents the position Z and the vertical axis represents brightness) of the reflected projection image into the position x using the calibration curve (1).

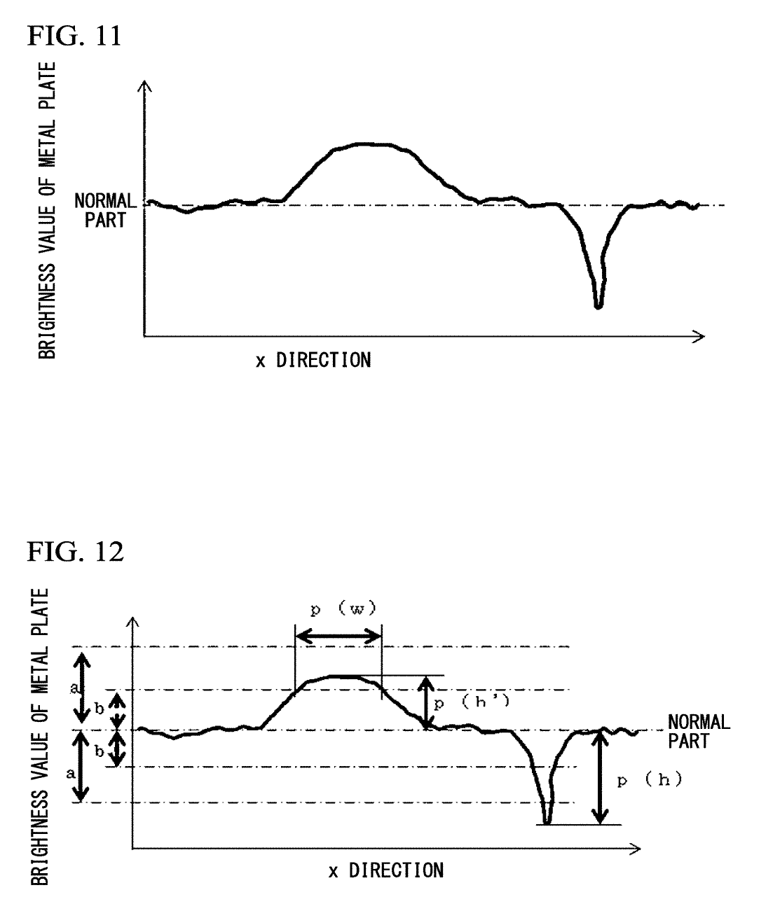

FIG. 10 illustrates an example of the brightness distribution of the reflected projection image, and FIG. 11 illustrates an example of the brightness distribution of the metal plate.

<Method for Specifying Repair Part of Irregular Defect and Quantifying Intensity of Brightness of Irregular Defect Using Brightness Distribution of Metal Plate>

This method corresponds to a method for determining a repair part of the irregular defect of the metal plate, and quantifying intensity of brightness of the irregular defect based on the brightness distribution of the metal plate in process (1).

In addition to an irregular defect having a large depth or height, an irregular defect, a spread of which is large, corresponds to an irregular defect of the metal plate to be repaired even when the irregular defect has a small depth or height.

In the invention, it is possible to specify a part of the irregular defect of the metal plate to be repaired and determine a repair amount by quantifying the depth or height and spread of the irregular defect of the metal plate as intensity of brightness of the irregular defect based on the brightness distribution of the metal plate.

Examples of a method for determining the repair part and the repair amount include the following methods.

(Method A) Method for determining the repair part and the repair amount through direction quantification using the brightness distribution of the metal plate

(Method B) Method for determining the repair part and the repair amount by converting the brightness distribution of the metal plate into an angle change rate distribution of the metal plate and quantifying the distribution

(Method C) Method for determining the repair part and the repair amount by converting the brightness distribution of the metal plate into a height distribution of a shape of the metal plate and quantifying the distribution

Hereinafter, the respective methods will be described in detail.

<(Method A) Method for Determining Repair Part and Repair Amount Through Direction Quantification Using Brightness Distribution of Metal Plate>

The method for determining the repair part and the repair amount through direction quantification using the brightness distribution of the metal plate corresponds to a method for detecting a part indicating a peak satisfying at least one of conditions (i) and (ii) below among peaks in the brightness distribution of the metal plate as a part that requires repair of the irregular defect of process (2) (hereinafter, abbreviated as “a repair part”).

A height or depth of a peak described below refers to a height or depth of a peak corresponding to a case in which an average value of brightness values of the normal part in the brightness distribution of the metal plate is set as a base line.

In addition, the average value of the brightness values of the normal part refers to a value obtained by averaging brightness values of the normal part in a region including the irregular defect corresponding to a square region having twice or more of a length of the irregular defect when a part other than the irregular defect is set to the normal part.

(i) A height or a depth p(h) of a peak is greater than or equal to a predetermined value “a”.

(ii) A width p(w) of a peak at a brightness value, at which a difference between the average value of the brightness values of the normal part and a brightness value of a peak of the brightness distribution of the irregular defect is a predetermined value b, is greater than or equal to a predetermined value c.

Condition (i) is an index related to a height or a depth of the irregular defect of the metal plate. Reflected light reflected on the irregular defect of the metal plate is condensed in the case of the concave defect and scattered in the case of the convex defect. Therefore, in the brightness distribution of the metal plate, a brightness value of the concave defect increases as a depth of the concave defect increases, and a brightness value of the convex defect decreases as a height of the convex defect increases.

From this aspect, it is possible to quantify the height or the depth of the irregular defect of the metal plate using the brightness value of the metal plate, and to specify a part in which a height or a depth p(h) of a peak is greater than or equal to a predetermined value “a” as a repair part in the brightness distribution of the metal plate.

FIG. 12 is the same figure as FIG. 11. The height or the depth p(h) of the peak in the brightness distribution of the metal plate indicates an absolute value of a difference between the average value of the brightness values of the normal part and a brightness value of the height or the depth of the peak. In FIG. 12, a right peak has a depth p(h) greater than or equal to “a”, and thus is determined to correspond to a repair part. The value “a” may be appropriately determined based on a purpose and use of the metal plate. For example, when the purpose of the metal plate corresponds to a mold for manufacturing a resin molded body, the value “a” may be appropriately determined using, as a sample, a resin molded body whose measurement condition of brightness distribution data and irregular defect degree are known.

Condition (ii) is an index related to the spread of the irregular defect of the metal plate. A width p(w) of an irregular defect at a brightness value, at which a difference between the average value of the brightness values of the normal part and a brightness value of a peak of a brightness distribution in an irregular defect portion is the predetermined value b, is used as an index of the spread of the irregular defect of the metal plate.

The value b is a lower limit at which a defect may be visually recognized as the irregular defect of the metal plate, and is determined by a used light source. For example, depending on the light source to be used, the value b may be appropriately determined using a resin molded body, in which a measurement condition of brightness distribution data and an irregular defect degree are known, as a sample. A part in which p(w) is equal to or larger than the predetermined value c may be specified as a repair part.

The value c may be appropriately determined based on a purpose and use of the metal plate. For example, when the purpose of the metal plate corresponds to a mold for manufacturing a resin molded body, the value c may be appropriately determined using, as a sample, a resin molded body whose measurement condition of brightness distribution data and irregular defect degree are known.

For example, in FIG. 12, when a width p(w) of a left peak is greater than or equal to the value c, a part corresponding thereto is determined to be a repair part.

<(Method A′) Method for Determining Repair Part and Repair Amount Through Direction Quantification Using Brightness Distribution of Metal Plate>

In the invention, condition (i′) below may be used instead of condition (i) of the above (Method A) as an index related to a height or a depth of the irregular defect of the metal plate.

(i′) Michelson contrast (MC) calculated by Equation (1) below is greater than or equal to a predetermined value d.

MC=(Lmax−Lmin)/(Lmax+Lmin) (1)

(In the case of the concave defect, Lmax represents a maximum brightness value of a convex peak, and Lmin represents an average value of brightness values of the normal part. In the case of the convex defect, Lmax represents an average value of brightness values of the normal part, and Linin represents a minimum brightness value of a concave peak.)

Michelson contrast is expressed by Equation (1), and is a numerical value of contrast recognized as a difference in brightness value of a metal plate.

As described above, reflected light reflected on the irregular defect of the metal plate is condensed in the case of the concave defect and scattered in the case of the convex defect. Thus, in the brightness distribution of the metal plate, the brightness value of the concave defect increases as the depth of the concave defect increases, and the brightness value of the convex defect decreases as the height of the convex defect increases. Therefore, contrast is generated according to the irregular defect in the brightness distribution of the metal plate.

From this aspect, it is possible to quantify the height or the depth of the irregular defect of the metal plate using Michelson contrast, and to specify a part in which Michelson contrast is greater than or equal to the predetermined value d as a repair part in the brightness distribution of the metal plate.

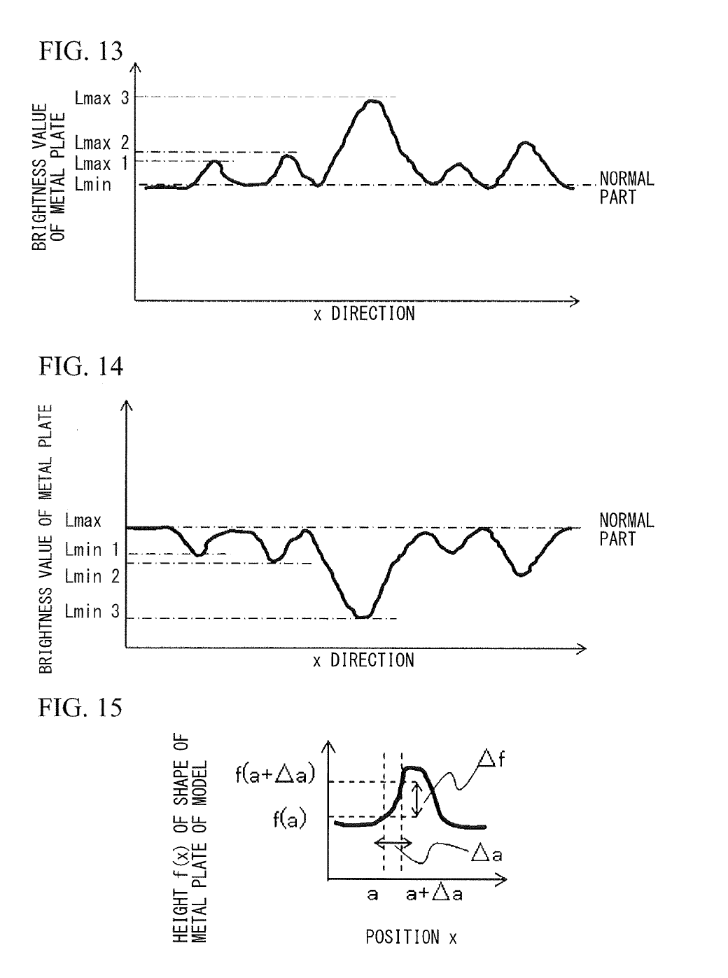

FIG. 13 illustrates a brightness distribution of a metal plate having the concave defect. The concave defect of the metal plate indicates a convex peak in the brightness distribution of the metal plate. A brightness value of a height of each peak is set to Lmax, and an average value of brightness values of a normal part is set to Lmin to obtain Michelson contrast for each peak, and a part having a value greater than or equal to the value d is set to a repair part.

FIG. 14 is an example of the case of the convex defect. The convex defect of the metal plate indicates a concave peak in the brightness distribution of the metal plate. An average value of brightness values of the normal part is set to Lmax, and a brightness value of a depth of each peak is set to Lmin to obtain Michelson contrast for each peak, and a part having the value d or more is set to a repair part. The value d may be appropriately determined according to a purpose or use of the metal plate. For example, when the purpose of the metal plate corresponds to a mold for manufacturing a resin molded body, the value d may be appropriately determined using, as a sample, a resin molded body whose measurement condition of brightness distribution data and irregular defect degree are known.

<(Method B) Method for Determining Repair Part by Converting Brightness Distribution of Metal Plate into Angle Change Rate Distribution of Metal Plate and Quantifying Distribution>

This method corresponds to a method for detecting the repair part by converting the brightness distribution of the metal plate into an angle change rate distribution of the metal plate, replacing a peak in the obtained angle change rate distribution of the metal plate with a peak of the brightness distribution of the metal plate of the above-described (Method A), and quantifying the peak of the angle change rate distribution of the metal plate.

Specifically, This method corresponds to a method for detecting a part indicating a peak satisfying at least one of conditions (iii) and (iv) below among peaks in the angle change rate distribution of the metal plate as a repair part of process (2).

(iii) A height or a depth p(h) of a peak is greater than or equal to a predetermined value e.

(iv) A width p(w) of a peak at an angle change rate of the metal plate, at which a difference between an average value of angle change rates of the metal plate of the normal part and a peak value of an angle change rate of an irregular defect portion is a predetermined value f, is greater than or equal to a predetermined value g.

Reflected light reflected from an irregular defect in which the angle change rate of the metal plate is large (a part in which an angle of a shape of the irregular defect rapidly changes) is condensed in the case of the concave defect and is scattered in the case of the convex defect. Therefore, there is a correlation between the angle change rate distribution of the metal plate and the brightness distribution of the metal plate.

In order to convert the brightness distribution of the metal plate into the angle change rate distribution of the metal plate, a metal plate of a model having an irregularity recognized as a defect is manufactured, each of an angle change rate distribution and a brightness distribution of the irregularity is obtained for the metal plate of the model, and a calibration curve (2) indicating a relationship between an angle change rate and a brightness value of the irregularity needs to be prepared.

For example, the angle change rate distribution of the irregularity may be measured using a contact type surface roughness meter, a non-contact type laser displacement meter or a white interferometer.

<Method for Calculating Angle Change Rate of Metal Plate>

(1) A curve f(x) is obtained by setting a height or depth of the irregularity at a position x on the metal surface to f(x), setting a horizontal axis to x, and setting a vertical axis to f(x).

(2) First-order differentiation of f(x) is calculated to obtain an angle f(x) at the position x.

(3) First-order differentiation of the angle f(x) is calculated to obtain an angle change rate f′(x).

A method for preparing the calibration curve (2) will be described below with reference to drawings.

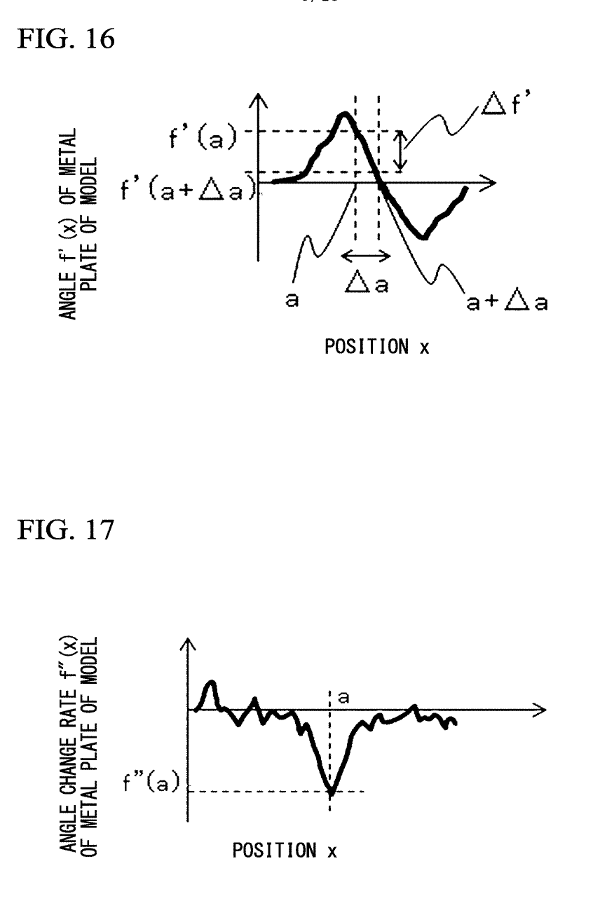

FIG. 15 is a curve f(x) of a convex defect obtained by measuring the surface of the metal plate of the model using the laser displacement meter. When Δf (=f(a+Δa)−f(a)) represents the amount of change in height of the shape of the convex defect in a minute section Δa, Δf/Aa represents an average slope of the convex defect in the minute section Δa. In FIG. 16, f(a) represents a limit value Δf/Δa in terms of an angle (deg) when Δa approaches 0 (a slope 1 represents 45 degrees in terms of an angle), and f(a) is an angle of the convex defect at the position a.

FIG. 16 is a curve plotted by setting a horizontal axis to a position x, and a vertical axis to an angle f(a). When an angle of the minute section Δa is set to Δf (=f(a+Δa)−f(a)), Δf/Δa represents an average slope of the angle in the minute section Δa. In FIG. 17, f′(a) represents a limit value Δf/Δa when Δa approaches 0, and is set to an angle change rate. FIG. 17 is a curve (angle change rate distribution) plotted by setting a horizontal axis to a position x, and a vertical axis to an angle change rate f′(x).

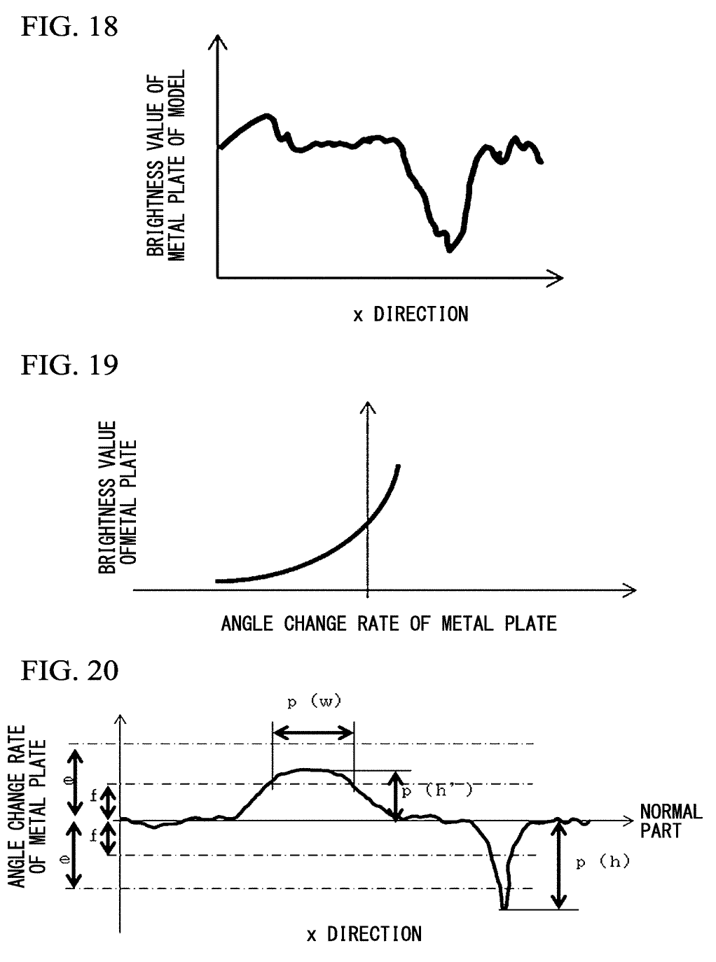

FIG. 18 is the brightness distribution of the metal plate of the model.

A calibration curve (2) illustrated in FIG. 19 is obtained by plotting from FIG. 17 and FIG. 18 when a horizontal axis represents an angle change rate at a position x of the angle change rate distribution of the metal plate (curve of an angle change rate in which a horizontal axis represents the position x and a vertical axis represents the angle change rate), and a vertical axis represents a brightness value at the position x of the brightness distribution of the metal plate (curve in which a horizontal axis represents the position x and a vertical axis represents brightness).

FIG. 20 is obtained by converting the brightness distribution of the metal plate of FIG. 12 into the angle change rate distribution of the metal plate using the calibration curve (2).

Condition (iii) is an index related to a height or a depth of the irregular defect.

In the angle change rate distribution of the metal plate, the angle change rate of the concave defect increases as the depth of the concave defect increases, and the angle change rate of the convex defect decreases as the height of the convex defect increases.

From this aspect, it is possible to quantify the height or the depth of the irregular defect using the angle change rate of the metal plate, and to specify a part in which a height or a depth p(h) of a peak is greater than or equal to the predetermined value e as a repair part in the angle change rate distribution of the metal plate.

The height or the depth p(h) of the peak in the angle change rate distribution of the metal plate of FIG. 20 indicates an absolute value of a difference between an average value of angle change rates of the normal part and an angle change rate of a height or a depth of a peak.

In FIG. 20, a right peak has a depth p(h) greater than or equal to e, and thus is determined to correspond to a repair part. The value e may be appropriately determined based on a purpose and use of the metal plate. For example, when the purpose of the metal plate corresponds to a mold for manufacturing a resin molded body, the value e may be appropriately determined using, as a sample, a resin molded body whose measurement condition of brightness distribution data and irregular defect degree are known.

Condition (iv) is an index related to the spread of the irregular defect.

A width p(w) of the irregular defect at an angle change rate, at which a difference between an average value of angle change rates of the normal part and a peak value of the angle change rate of the irregular defect portion is the predetermined value f, is an index of the spread of the irregular defect of the metal plate.

The value f is a lower limit at which a defect may be visually recognized as the irregular defect of the metal plate, and is determined by a used light source. A part in which p(w) is greater than or equal to the predetermined value g may be specified as a repair part. The value g may be appropriately determined based on a purpose and use of the metal plate. For example, when the purpose of the metal plate corresponds to a mold for manufacturing a resin molded body, the value g may be appropriately determined using, as a sample, a resin molded body whose measurement condition of brightness distribution data and irregular defect degree are known.

For example, in FIG. 20, when a width p(w) of a left peak is greater than or equal to the value g, a part corresponding thereto is determined to be a repair part.

<(Method C) Method for Determining Repair Part by Converting Brightness Value Distribution of Metal Plate into Height Distribution of Shape of Metal Plate and Quantifying Distribution>

This method corresponds to a method for detecting the repair part by converting a brightness value distribution of the metal plate into a height distribution of the shape of the metal plate, converting an angle change rate distribution of the metal plate into the height distribution of the shape of the metal plate, replacing a peak in the obtained high distribution of the shape of the metal plate with a peak of the brightness distribution of the metal plate of the above-described (Method A), and quantifying the peak of the angle change rate distribution of the metal plate.

Specifically, This method corresponds to a method for detecting a part indicating a peak satisfying at least one of conditions (v) and (vi) below among peaks in the height distribution of the shape of the metal plate as a repair part of process (2).

(v) A height or a depth of a peak is greater than or equal to a predetermined value h.

(vi) A width of a peak at a height of the shape, at which a difference between an average value of heights of a shape of the normal part and a peak value of a height distribution of a shape of an irregular defect portion corresponds to a predetermined value i, is greater than or equal to a predetermined value j.

The height distribution of the shape of the metal plate may be calculated by a method below using the angle change rate distribution of the metal plate obtained by converting the brightness distribution of the metal plate.

<Method for Calculating Height Distribution of Shape of Metal Plate>

(1) An angle f′(x) is obtained by integrating an angle change rate f″(x).

(2) A height f(x) of the shape is obtained by integrating the angle f′(x).

(3) A height distribution (curve in which a horizontal axis represents a position x and a vertical axis represents f(x)) of the shape is obtained by setting a horizontal axis to x and a vertical axis to f(x).

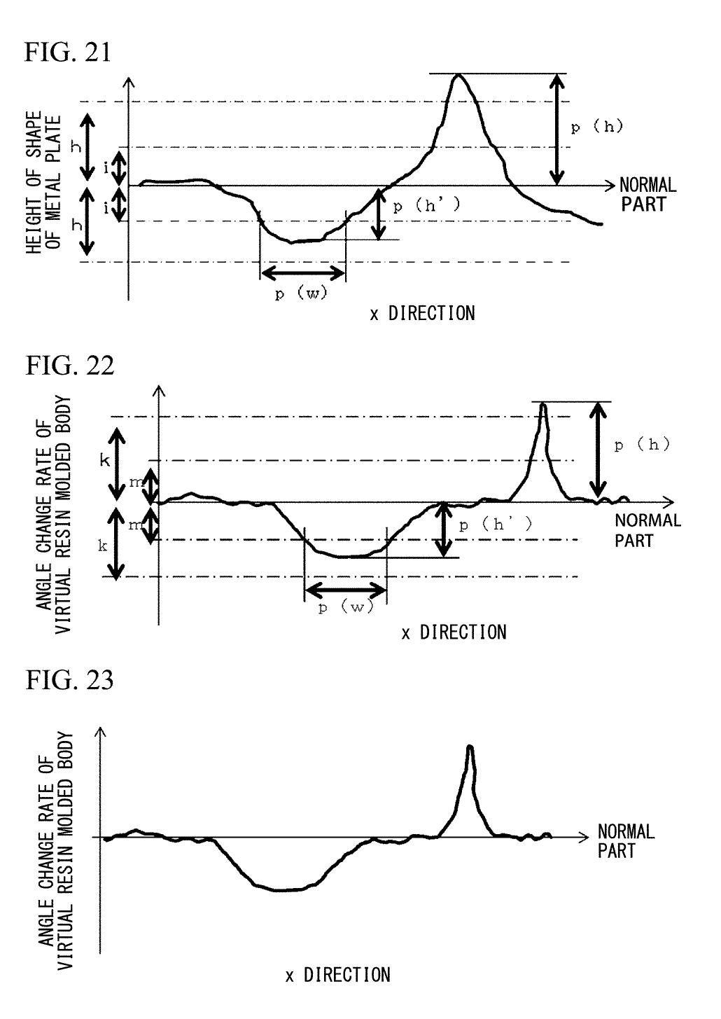

FIG. 21 is the height distribution of the shape of the metal plate calculated by the above items (1) to (3) from the brightness distribution of the metal plate of FIG. 12.

Condition (v) is an index related to the height or the depth of the irregular defect of the metal plate.

In the height distribution of the shape of the metal plate, a part in which a height or a depth p(h) of a peak is greater than or equal to the predetermined value h may be specified as a repair part.

A height or a depth p(h) of a peak at a height of a shape of the metal plate of FIG. 21 indicates an absolute value of a difference between an average value of heights of a shape of a normal part and a height of a shape of a height or a depth of a peak.

In FIG. 21, a right peak is determined to correspond to a repair part since the depth p(h) is greater than or equal to the value h. The value h may be appropriately determined based on a purpose and use of the metal plate. For example, when the purpose of the metal plate corresponds to a mold for manufacturing a resin molded body, the value h may be appropriately determined using, as a sample, a resin molded body whose measurement condition of brightness distribution data and irregular defect degree are known.

Condition (vi) is an index related to the spread of the irregular defect of the metal plate.

A width p(w) of an irregular defect at a height of a shape, a difference of which from the average value of the heights of the shape of the normal part is the predetermined value i, is an index of the spread of the irregular defect.

The value i is a lower limit at which a defect may be visually recognized as the irregular defect of the metal plate, and is determined by a used light source. For example, the value i may be appropriately determined by the used light source using, as a sample, a resin molded body whose measurement condition of brightness distribution data and irregular defect degree are known. A part in which p(w) is greater than or equal to the predetermined value j may be specified as a repair part. The value j may be appropriately determined based on a purpose and use of the metal plate. For example, when the purpose of the metal plate corresponds to a mold for manufacturing a resin molded body, the value j may be appropriately determined using, as a sample, a resin molded body whose measurement condition of brightness distribution data and irregular defect degree are known.

For example, in FIG. 21, when a width p(w) of a left peak is greater than or equal to the value j, a part corresponding thereto is determined to be a repair part.

Hereinbefore, a description has been given of the method for determining the repair part of the irregular defect based on the brightness distribution of the metal plate. However, when the metal plate is a mold for a resin molded body, the irregular defect has a problem as an irregular defect of the resin molded body. Therefore, in this case, the repair part of the irregular defect may be determined using (Method D) to (Method F) below.

When a resin molded body is molded using a mold of a metal plate, an irregular defect of the metal plate is transferred to the resin molded body, and is recognized as an irregular defect of the resin molded body. Therefore, whether a defect is an irregular defect to be repaired is preferably determined based on the irregular defect of the resin molded body, and a part of the metal plate to be repaired may be determined using a calibration curve of a brightness value and an angle change rate in the resin molded body.

Examples of a specific method include the following methods.

(Method D) Method for determining a repair part by converting a brightness distribution of a metal plate into an angle change rate distribution of a virtual resin molded body

(Method E) Method for determining a repair part by converting a brightness distribution of a metal plate into a brightness distribution of a virtual resin molded body

(Method F) Method for determining a repair part by converting a brightness distribution of a metal plate into a height distribution of a shape of a virtual resin molded body

Hereinafter, the respective methods will be described in detail

<(Method D) Method for Determining Repair Part by Converting Brightness Distribution of Metal Plate into Angle Change Rate Distribution of Virtual Resin Molded Body>

This method corresponds to a method for converting a brightness distribution of a metal plate into an angle change rate distribution of the metal plate, inverting and converting the obtained angle change rate distribution of the metal plate into an angle change rate distribution of a virtual resin molded body,

replacing a peak in the obtained angle change rate distribution of the virtual resin molded body with a peak of the brightness distribution of the metal plate of the above-described (Method A), and quantifying the peak of the angle change rate distribution of the virtual resin molded body, thereby detecting a repair part.

Specifically, This method corresponds to a method for determining a part indicating a peak satisfying at least one of conditions (vii) and (viii) below among peaks in the angle change rate distribution of the virtual resin molded body, and detecting a part of the metal plate corresponding to the part as a repair part of process (2).

(vii) A height or a depth p(h) of a peak is greater than or equal to a predetermined value k.

(viii) A width p(w) of a peak at an angle change rate, at which a difference between an average value of angle change rates of a normal part and a peak value of an angle change rate distribution of an irregular defect portion is a predetermined value m, is greater than or equal to a predetermined value n.

The method for converting the brightness distribution of the metal plate into the angle change rate distribution of the metal plate may be performed using the same method as the conversion method in the above (Method B).

When a resin molded body is molded using a mold of a metal plate, an irregular defect of the metal plate is transferred to the resin molded body, and thus a concave defect of the metal plate corresponds to a convex defect of the resin molded body, and a convex defect of the metal plate corresponds to a concave defect of the resin molded body.

Therefore, even when the resin molded body is not actually molded, a distribution obtained by inverting an angle change rate distribution of the metal plate indicates an angle change rate distribution of the resin molded body. Thus, the angle change rate distribution obtained by inversion may be used as the angle change rate distribution of the virtual resin molded body.

FIG. 22 is obtained by converting the virtual resin molded body of the brightness distribution of the metal plate of FIG. 12 into the angle change rate distribution of the virtual resin molded body.

Condition (vii) is an index related to a height or a depth of an irregular defect of a resin molded body. A part in which p(h) is greater than or equal to the predetermined value k may be determined, and a part of the metal plate corresponding to the part may be specified as a repair part. The value k may be appropriately determined based on a purpose and use of the resin molded body. For example, when the purpose of the resin molded body corresponds to a mold for manufacturing a resin molded body, the value k may be appropriately determined using, as a sample, a resin molded body whose measurement condition of brightness distribution data and irregular defect degree are known.

Condition (viii) is an index related to a spread of an irregular defect of the resin molded body. A part in which p(w) is greater than or equal to the predetermined value n may be determined, and a part of the metal plate corresponding to the part may be specified as a repair part.

The value n may be appropriately determined based on a purpose and use of the resin molded body. For example, when the purpose of the resin molded body corresponds to a mold for manufacturing a resin molded body, the value n may be appropriately determined using, as a sample, a resin molded body whose measurement condition of brightness distribution data and irregular defect degree are known.

<(Method E) Method for Determining Repair Part by Converting Brightness Distribution of Metal Plate into Brightness Distribution of Virtual Resin Molded Body>

This method corresponds to a method for converting a brightness distribution of a metal plate into an angle change rate distribution of the metal plate, inverting and converting the angle change rate distribution of the metal plate into an angle change rate distribution of a virtual resin molded body, converting the angle change rate distribution of the virtual resin molded body into a brightness distribution of the virtual resin molded body, replacing a peak in the obtained brightness distribution of the virtual resin molded body with a peak of the brightness distribution of the metal plate of the above-described (Method A), and quantifying the peak of the brightness distribution of the virtual resin molded body, thereby detecting a repair part.

Specifically, This method corresponds to a method for determining a part indicating a peak satisfying at least one of conditions (ix) and (x) below among peaks in the brightness distribution of the virtual resin molded body, and detecting a part of the metal plate corresponding to the part as a repair part of process (2).

(ix) A height or a depth p(h) of a peak is greater than or equal to a predetermined value o.

(x) A width p(w) of a peak at a brightness value, at which a difference between an average value of brightness values of a normal part and a peak value of a brightness distribution of an irregular defect portion is a predetermined value q, is greater than or equal to a predetermined value r.

The method for converting the brightness distribution of the metal plate into the angle change rate distribution of the virtual resin molded body may be performed using the same method as the conversion method in the above (Method D).

FIG. 23 is a graph illustrating the angle change rate distribution of the virtual resin molded body obtained by inverting the angle change rate distribution of the metal plate of FIG. 20.

In order to convert the angle change rate distribution of the virtual resin molded body into the brightness distribution of the virtual resin molded body, a resin molded body of a model having an irregularity recognized as a defect is manufactured, each of an angle change rate distribution and a brightness distribution of the irregularity is obtained for the resin molded body of the model, and a calibration curve (3) indicating a relationship between an angle change rate and a brightness value of the irregularity needs to be prepared. Hereinafter, a description will be given of a method for preparing the calibration curve (3).

The angle change rate distribution of the resin molded body of the model may be obtained by being converted from a curve f(x) (not illustrated) of a convex defect of the resin molded body of the model similarly to the above item (B).

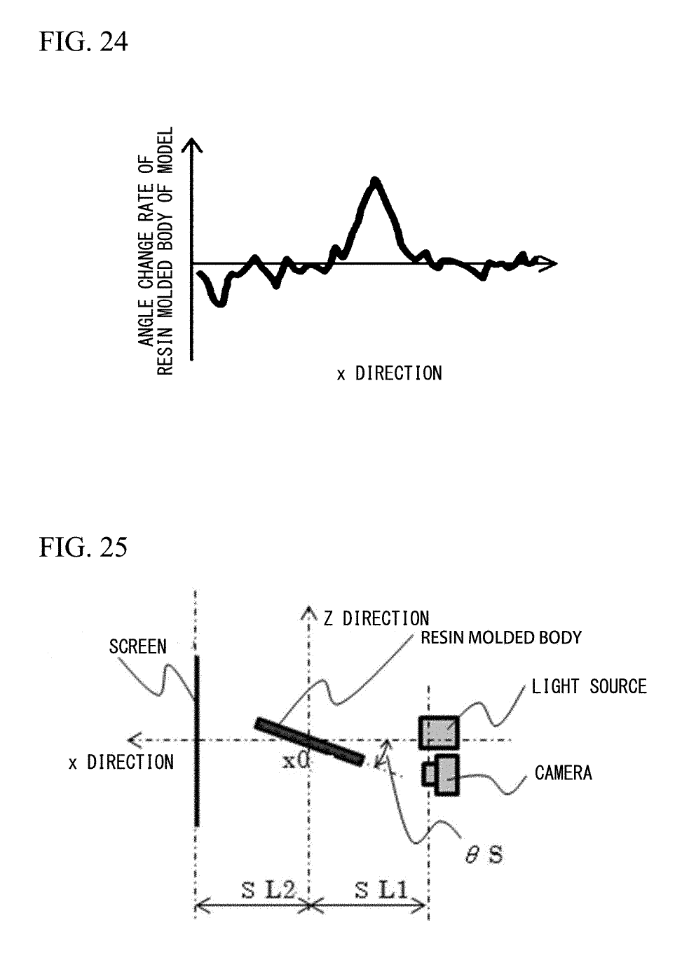

For example, the curve f(x) of the convex defect of the resin molded body of the model may be obtained using a contact type surface roughness meter, a non-contact type laser displacement meter or a white interferometer. FIG. 24 is a graph illustrating the angle change rate distribution of the resin molded body of the model obtained in this way. A brightness distribution of the resin molded body of the model may be obtained using the following method.

An irregular state may be converted into a brightness distribution when light is incident on a region including an irregular defect present on a surface of a resin molded body from a light source, transmitted light transmitting the resin molded body is projected on a screen, a transmitted projection image projected on the screen is photographed using a camera, brightness of the obtained image is measured to obtain a brightness distribution of the transmitted projection image, and a brightness distribution of the transmitted projection image is converted into a brightness distribution of the resin molded body.

A detailed description will be given of a method for obtaining the brightness distribution of the transmitted projection image with reference to FIG. 25. The light source is disposed at a position away from a central portion x0 of a defect of the resin molded body by SL1 in a negative direction of an x axis. The screen is disposed parallel to a Z direction at a position away from the central portion x0 of the defect of the resin molded body by SL2 in a positive direction of the x axis. The resin molded body is disposed at an elevation angle θS with respect to the x axis.

SL1 is preferably a short distance within a range in which the light source may be installed. SL2 is preferably a short distance within a range in which the screen may be installed. When SL1, SL2, and θS are within this range, light from the light source may be efficiently used. θS is preferably 5° or more.

The camera is preferably installed at a position at which the whole transmitted projection image projected on the screen may be photographed. As the light source, the screen, and the camera, those used in the method for converting the irregular state of the metal plate into the brightness distribution of the metal plate may be used.

Light emitted from the light source is incident on the resin molded body at a right angle with respect to the screen. Light transmitted through the resin molded body forms an image on the screen, and a transmitted projection image of a region including the irregular defect present on the surface of the resin molded body is projected as a monochrome grayscale image on the screen.

Light transmitted through the irregular defect is scattered in the case of a concave defect, and is condensed in the case of a convex defect. Therefore, as a depth of the concave defect of the resin molded body increases, a brightness value of the transmitted projection image of the concave defect on the screen decreases. In addition, as a height of the convex defect of the resin molded body increases, a brightness value of the transmitted projection image of the convex defect on the screen increases.

The monochrome grayscale image projected on the screen is photographed using the camera, and a brightness distribution of the transmitted projection image is obtained.

Similarly to the method for obtaining the brightness distribution of the reflected projection image of the metal plate, the brightness distribution of the transmitted projection image may be obtained by extracting a plurality of lines from a region including the irregular defect and a normal part around the irregular defect on a digital image using image processing software, and obtaining brightness values with respect to for all pixels present in the respective lines.

Similarly to the method for obtaining the brightness distribution of the metal plate, the brightness distribution of the resin molded body (curve in which a horizontal axis represents a position x and a vertical axis represents brightness) may be obtained by preparing a calibration curve (not illustrated), and converting a position Z of the brightness distribution of the transmitted projection image (curve in which a horizontal axis represents the position Z and a vertical axis represents brightness).

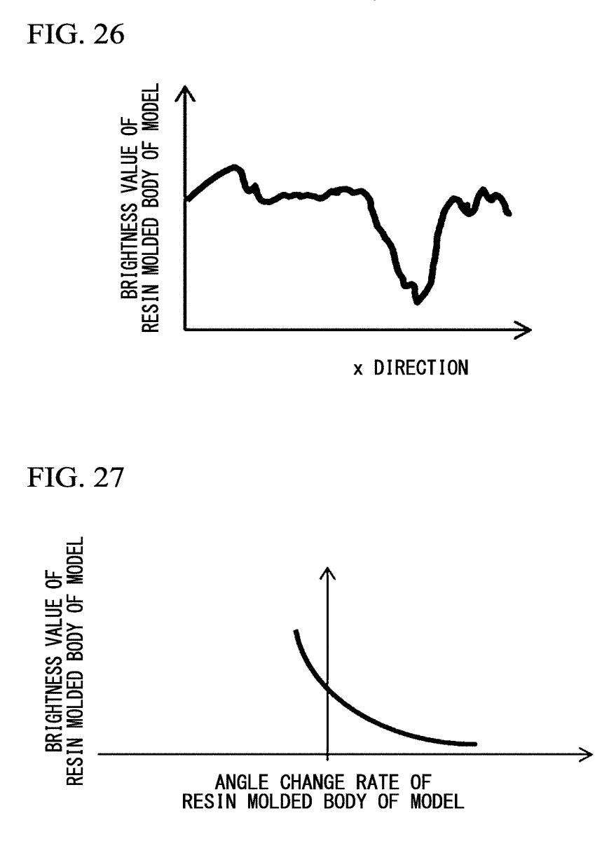

FIG. 26 is a graph illustrating a brightness distribution of a resin molded body of a model obtained in this way.

A calibration curve (3) illustrated in FIG. 27 is obtained by plotting from FIG. 24 and FIG. 26 when a horizontal axis represents an angle change rate at a position x of an angle change rate distribution of the resin molded body of the model (curve of an angle change rate in which a horizontal axis represents the position x and a vertical axis represents the angle change rate), and a vertical axis represents a brightness value at the position x of the brightness distribution of the resin molded body of the model (curve in which a horizontal axis represents the position x and a vertical axis represents brightness).

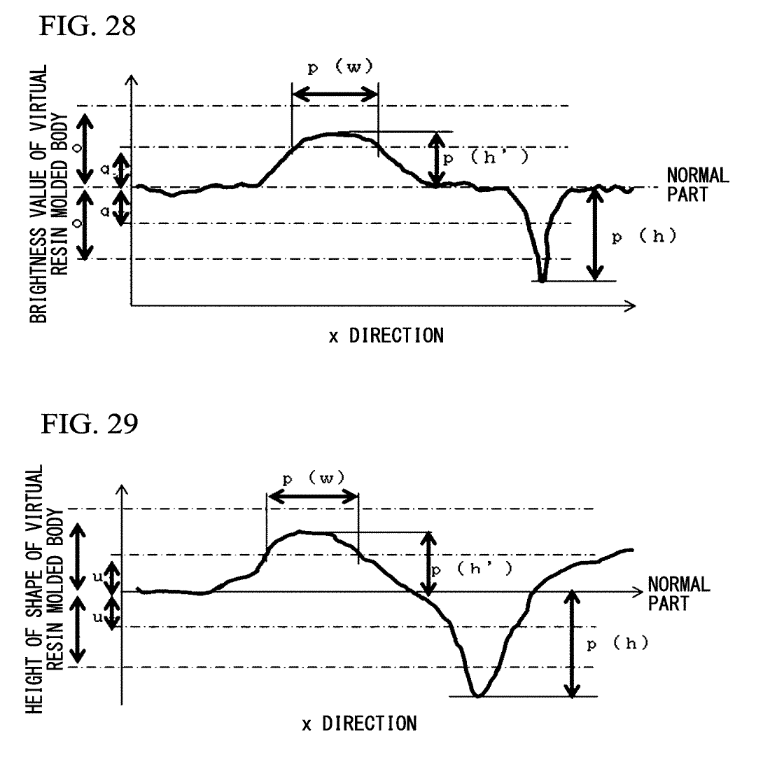

FIG. 28 is obtained by converting the angle change rate distribution of the virtual resin molded body (FIG. 23) into the brightness distribution of the virtual resin molded body using the calibration curve (3).

Condition (ix) is an index related to a height or a depth of an irregular defect. A part in which p(h) is greater than or equal to the predetermined value o may be determined, and a part of the metal plate corresponding to the part may be specified as a repair part. The value o may be appropriately determined based on a purpose and use of the resin molded body. For example, when the purpose of the resin molded body corresponds to a mold for manufacturing a resin molded body, the value o may be appropriately determined using, as a sample, a resin molded body whose measurement condition of brightness distribution data and irregular defect degree are known.

Condition (x) is an index related to a spread of an irregular defect. A part in which p(w) is greater than or equal to the predetermined value r may be determined, and a part of the metal plate corresponding to the part may be specified as a repair part. The value r may be appropriately determined based on a purpose and use of the resin molded body. For example, when the purpose of the resin molded body corresponds to a mold for manufacturing a resin molded body, the value r may be appropriately determined using, as a sample, a resin molded body whose measurement condition of brightness distribution data and irregular defect degree are known.

<(Method E′) Method for Determining Repair Part by Converting Brightness Distribution of Metal Plate into Brightness Distribution of Virtual Resin Molded Body>

In the above (Method E), condition (ix′) below may be used as an index related to a height or a depth of an irregular defect instead of the above condition (ix) (Method E′).

(ix′) Michelson contrast (MC) calculated by Equation (1) below is greater than or equal to a predetermined value s.

MC=(Lmax−Lmin)/(Lmax+Lmin) (1)

(In the case of the concave defect, Lmax represents a maximum brightness value of a convex peak, and Lmin represents an average value of brightness values of the normal part. In the case of the convex defect, Lmax represents an average value of brightness values of the normal part, and Linin represents a minimum brightness value of a concave peak.)

A part in which Michelson contrast is greater than or equal to the predetermined value s may be determined, and a part of the metal plate corresponding to the part may be specified as the repair part of process (2).

The value s may be appropriately determined based on a purpose or use of the resin molded body.

<(Method F) Method for Determining Repair Part by Converting Brightness Distribution of Metal Plate into Height Distribution of Shape of Virtual Resin Molded Body>

This method corresponds to a method for detecting a repair part by converting a brightness distribution of a metal plate into an angle change rate distribution of the metal plate, inverting and converting the angle change rate distribution of the metal plate into an angle change rate distribution of a virtual resin molded body, converting the angle change rate distribution of the virtual resin molded body into a brightness distribution of the virtual resin molded body, replacing a peak in the obtained brightness distribution of the virtual resin molded body with the peak of the brightness distribution of the metal plate of the above-described (Method A), and quantifying the peak of the brightness distribution of the virtual resin molded body.

Specifically, this method corresponds to a method for determining a part indicating a peak satisfying at least one of conditions (ix) and (x) below among peaks in the brightness distribution of the virtual resin molded body, and detecting a part of the metal plate corresponding to the part as a repair part of process (2).

This method corresponds to a method for detecting a repair part by converting a brightness distribution of a metal plate into an angle change rate distribution of the metal plate, converting the angle change rate distribution of the metal plate into a height distribution of a shape of the metal plate, inverting and converting the obtained height distribution of the shape of the metal plate into a height distribution of a shape of a virtual resin molded body, replacing a peak in the obtained height distribution of the shape of the virtual resin molded body with the peak of the brightness distribution of the metal plate of the above-described (Method A), and quantifying the peak of the brightness distribution of the virtual resin molded body. Among these methods, there is a method for detecting a part indicating a peak satisfying at least one of conditions (xi) and (xii) below, and determining a part of the metal plate corresponding to the part as a repair part.

(xi) A height or a depth of a peak is greater than or equal to a predetermined value t.

(xii) A width of a peak at a height of a shape, at which a difference between an average value of heights of a shape of a normal part and a peak value of a height distribution of a shape of an irregular defect portion is a predetermined value u, is greater than or equal to a predetermined value v.

Examples of a method for converting the brightness distribution of the metal plate into the height distribution of the shape of the metal plate include the same method as the conversion method in the above (Method C).

The height distribution of the shape of the metal plate may be inverted and converted into the height distribution of the shape of the virtual resin molded body.

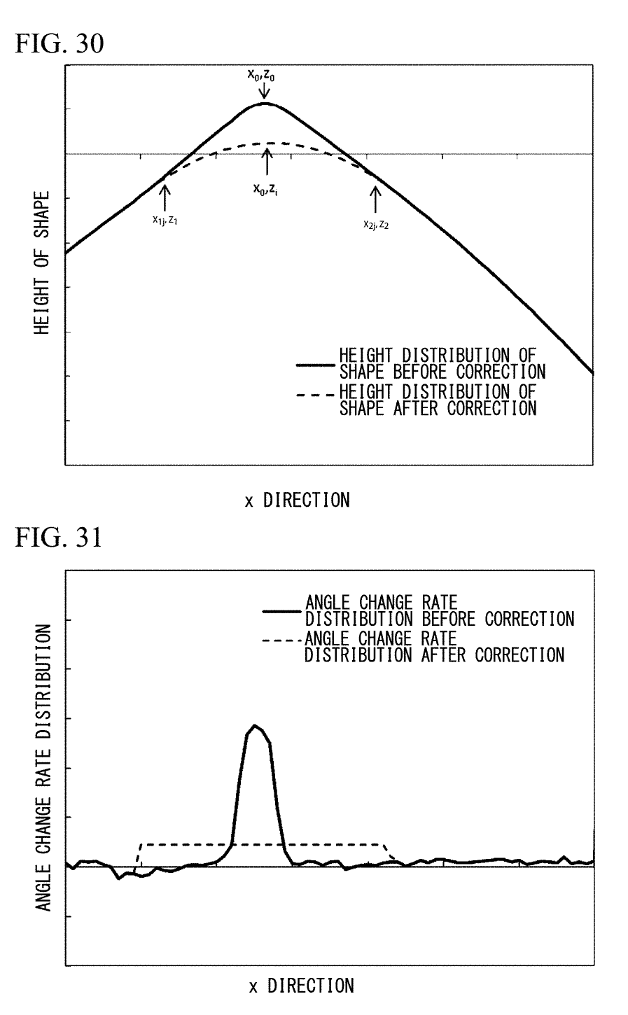

FIG. 29 is a height distribution of a shape of a virtual resin molded body obtained by inverting the height distribution (FIG. 21) of the shape of the metal plate obtained from the brightness distribution (FIG. 12) of the metal plate.

Condition (xi) is an index related to a height or a depth of an irregular defect of a resin molded body. A part in which p(h) is greater than or equal to the predetermined value t may be determined, and a part of the metal plate corresponding to the part may be specified as a repair part. The value t may be appropriately determined based on a purpose and use of the resin molded body. For example, when the purpose of the resin molded body corresponds to a mold for manufacturing a resin molded body, the value t may be appropriately determined using, as a sample, a resin molded body whose measurement condition of brightness distribution data and irregular defect degree are known.

Condition (xii) is an index related to a spread of the irregular defect of the resin molded body. A part in which p(w) is greater than or equal to the predetermined value v may be determined, and a part of the metal plate corresponding to the part may be specified as a repair part. The value v may be appropriately determined based on a purpose and use of the resin molded body. For example, when the purpose of the resin molded body corresponds to a mold for manufacturing a resin molded body, the value v may be appropriately determined using, as a sample, a resin molded body whose measurement condition of brightness distribution data and irregular defect degree are known.

It is determined that further repair is unnecessary when a part determined to require repair of an irregular defect is not detected in a process of determining whether repair of an irregular defect is necessary of process (1). Specifically, it is determined that further repair is unnecessary when a part indicating a peak satisfying a condition described in any one of (Method A) to (Method F) described below is not detected.

<Method for Determining Required Repair Amount Upon Repairing Irregular Defect of Metal Plate>

Examples of a method for determining a required repair amount of repair upon repairing the irregular defect of the metal plate, which is detected in process (1), in process (2) described below include the following methods.

(Method 1) Method for determining a required repair amount of repair from irregular defect data of the metal plate described in the above (Method A) to (Method C)

(Method 2) Method for determining a required repair amount of repair from irregular defect data of the virtual resin molded body described in the above (Method D) to (Method F)

<(Method 1) Method for Determining Required Repair Amount from Irregular Defect Data of Metal Plate>

A value obtained by converting a height or a depth of a peak detected as a repair part among the peaks of the brightness distribution of the metal plate described in item (i) of the above (Method A) into shape data is set to shape data X, and a value obtained by converting the predetermined value “a” into shape data is set to shape data Y. Then, the required repair amount of repair may be set to |X−Y| or more and |X| or less. Here, the shape data and the required repair amount are expressed in units of length.

Alternatively, a value obtained by converting a value of Michelson contrast (MC) of a peak detected as a repair part among the peaks of the brightness distribution of the metal plate described in item (i′) of the above (Method A′) into shape data is set to shape data X, and a value obtained by converting the predetermined value d into shape data is set to shape data Y. Then, the required repair amount of repair may be set to |X−Y| or more and |X| or less.

Alternatively, a value obtained by converting a height or a depth of a peak detected as a repair part among the peaks of the angle change rate distribution of the metal plate described in item (iii) of the above (Method B) into shape data is set to shape data X, and a value obtained by converting the predetermined value e into shape data is set to shape data Y. Then, the required repair amount of repair may be set to |X−Y| or more and |X| or less.

Alternatively, a value obtained by converting a height or a depth of a peak detected as a repair part among the peaks of the height distribution of the shape of the metal plate described in item (v) of the above (Method C) into shape data is set to shape data X, and a value obtained by converting the predetermined value h into shape data is set to shape data Y. Then, the required repair amount of repair may be set to |X−Y| or more and |X| or less.

Alternatively, a width of a peak at a brightness value, at which a difference between an average value of brightness values of the normal part of the peak detected as the repair part among the peaks of the brightness distribution of the metal plate described in item (ii) of the above (Method A) or item (ii) of the above (Method A′) and the brightness value of the peak of the brightness distribution of the irregular defect portion is the predetermined value b, is set to V, and the predetermined value c is set to W. Then, the required repair amount of repair may be set to |V−W| or more and |V| or less.

Alternatively, a width of a peak at an angle change rate, at which a difference between an average value of angle change rates of the metal plate of the normal part of the peak detected as the repair part among the peaks of the angle change rate distribution of the metal plate described in item (iv) of the above (Method B) and the peak value of the angle change rate of the irregular defect portion is the predetermined value f, is set to V, and the predetermined value g is set to W. Then, the required repair amount of repair may be set to |V−W| or more and |V| or less.

Alternatively, a width of a peak at a shape height, at which a difference between an average value of shape heights of the normal part of the peak detected as the repair art among the peaks of the height distribution of the shape of the metal plate described in item (vi) of the above (Method C) and a peak value of a height distribution of a shape of an irregular defect portion is the predetermined value i, is set to V, and the predetermined value j is set to W. Then, the required repair amount of repair may be set to |V−W| or more and |V| or less.

<(Method 2) Method for Determining Required Repair Amount from Irregular Defect Data of Virtual Resin Molded Body>

A value obtained by converting a height or a depth of a peak detected as a repair part among the peaks of the angle change rate distribution of the virtual resin molded body described in item (vii) of the above (Method D) into shape data is set to shape data X, and a value obtained by converting the predetermined value k into shape data is set to shape data Y. Then, the required repair amount of repair may be set to |X−Y| or more and |X| or less.

Alternatively, a value obtained by converting a height or a depth of a peak detected as a repair part among the peaks of the brightness distribution of the virtual resin molded body described in item (ix) of the above (Method E) into shape data is set to shape data X, and a value obtained by converting the predetermined value o into shape data is set to shape data Y. Then, the required repair amount of repair may be set to |X−Y| or more and |X| or less.

Alternatively, a value obtained by converting a value of Michelson contrast (MC) of a peak detected as a repair part among the peaks of the brightness distribution of the virtual resin molded body described in item (ix′) of the above (Method E′) into shape data is set to shape data X, and a value obtained by converting the predetermined value s into shape data is set to shape data Y. Then, the required repair amount of repair may be set to |X−Y| or more and |X| or less.

Alternatively, a value obtained by converting a height or a depth of a peak detected as a repair part among the peaks of the height distribution of the shape of the virtual resin molded body described in item (xi) of the above (Method F) into shape data is set to shape data X, and a value obtained by converting the predetermined value t into shape data is set to shape data Y. Then, the required repair amount of repair may be set to |X−Y| or more and |X| or less.

Alternatively, there is a method for determining |V−W| or more and |V| or less to be the required repair amount of repair by setting each value V and a predetermined value W with respect to a value of any one of combinations below.

Alternatively, a width of a peak at an angle change rate, at which a difference between an average value of angle change rates of the metal plate of the normal part of the peak detected as the repair part among the peaks of the angle change rate distribution of the virtual resin molded body described in item (viii) of the above (Method D) and the peak value of the angle change rate distribution of the irregular defect portion is the predetermined value in, is set to V, and the predetermined value n is set to W. Then, the required repair amount of repair may be set to |V−W| or more and |V| or less.

Alternatively, a width of a peak at a brightness value, at which a difference between an average value of brightness values of the normal part of the peak detected as the repair part among the peaks of the brightness distribution of the virtual resin molded body described in item (x) of the above (Method E) and the peak value of the brightness distribution of the irregular defect portion is the predetermined value q, is set to V, and the predetermined value r is set to W. Then, the required repair amount of repair may be set to |V−W| or more and |V| or less.

Alternatively, a width of a peak at a shape height, at which a difference between an average value of shape heights of the normal part of the peak detected as the repair part among the peaks of the height distribution of the shape of the virtual resin molded body described in item (xii) of the above (Method F) and the peak value of the height distribution of the shape of the irregular defect portion is the predetermined value u, is set to V, and the predetermined value v is set to W. Then, the required repair amount of repair may be set to |V−W| or more and |V| or less.

<Method for Converting Brightness Distribution or Angle Change Rate Distribution into Height Distribution of Shape>

Shape data of a metal plate is data of a height distribution of a shape of the metal plate. The height distribution of the shape of the metal plate may be obtained using the same method as the method for calculating the height distribution of the shape of the metal plate from the brightness distribution or the angle change rate distribution of the metal plate described in the above (Method C).

In addition, shape data of a virtual resin molded body is data of a height distribution of a shape of the virtual resin molded body. The height distribution of the shape of the virtual resin molded body may be obtained by inverting the height distribution of the shape of the metal plate. Hereinafter, a description will be given with reference to FIG. 30 and FIG. 31. Hereinafter, a shape height of a Y axis of FIG. 30 is set to f(x).

Shape data of the above-described predetermined value is obtained in the following procedure of (Process 1) to (Process 5).

(Process 1) A point 1 (x₁ⱼ, z₁) and a point 2 (x₂ⱼ, z₂) are provided at positions of xx mm at both sides of a vertex (x₀, z₀) of the height distribution on height distribution data (FIG. 30, a curve in which a horizontal axis represents a position x and a vertical axis represents f(x), a solid line) of the shape of the irregular detect portion.

(Process 2) In addition, a point i (x₀, z₁) is provided at a position of yy μm in a downward direction with respect to the vertical axis from the vertex (x₀, z₀) of the height distribution.

(Process 3) A circle arc passing through three points of the point 1 (x₁ⱼ, z₁), the point 2 (x₂ⱼ, z₂), and the point i (x₀, z₁) is provided.

(Process 4) When the circle arc provided in the above (Process 3) does not intersect a curve x−f(x) (a curve in which a horizontal axis represents a position x and a vertical axis represents a height f(x) of the shape), a curve including a circular arc passing through the three points of the point 1, the point 2, and the point i and the curve x−f(x) (however, a section of positions x1 to x2 is excluded) is set to a predicted height distribution of a shape after repair. When the circle arc provided in the above (Process 3) intersects the curve x−f(x), the operation returns to the above (Process 2) to further provide a point i+1 (x₀, zᵢ₊₁) at a position of yy μm in the downward direction with respect to the vertical axis, and a similar operation to that of the above (Process 3) and (Process 4) is repeated until the circle arc provided in the above (Process 3) does not intersect the curve x−f(x).

(Process 5) The height distribution of the shape after repair predicted in the above (Process 4) is converted into a brightness distribution or an angle change rate distribution. When a value less than a predetermined value is obtained at an arbitrary position x on a curve of the converted brightness distribution or angle change rate distribution, the predicted height distribution of the shape after repair is set to a height distribution of the shape after repair (FIG. 31, a dotted line). When a position x corresponding to the predetermined value or more is present on the curve of the converted brightness distribution or angle change rate distribution (FIG. 31, a solid line), the operation returns to the above (Process 1), and a point X1j+1 (x₁ⱼ₊₁, zᵢ) and a point X2j+2 (x₂ⱼ₊₁, zᵢ) are provided at positions of xx mm in both directions with respect to the horizontal axis. Subsequently, a similar operation to the above (Process 2) to (Process 5) is repeated until the converted brightness distribution or angle change rate distribution is less than the predetermined value at an arbitrary position x.

<Plastic Working>

Examples of plastic working include forging and press working. For example, forging may be a method for hitting a metal plate with a hammer. Examples of the hammer include a metal hammer and a plastic hammer. A cushioning material is preferably attached to a surface of the hammer so that a surface of the metal plate is not scratched due to direct contact with the surface of the hammer. Examples of the cushioning material include a gummed tape or a cloth.

Either a mechanical grinding method or a hand grinding method may be used as a grinding method. Examples of a grinding material include a grindstone or sandpaper. A grain size of the grinding material may be determined based on a size of a defect.

When an irregular defect of the metal plate is repaired, it is preferable to repair the irregular defect to obtain the same smooth state as that of the normal part of the metal plate.

In the invention, processes (1) and (2) are repeated until repair of the irregular defect on the surface of the metal plate is determined to be unnecessary in process (1).

When it is determined that repair is unnecessary in first process (1), the operation ends at this point.

When it is determined that repair is necessary in first process (1), a repair method for the invention further carries out process (2). Subsequently, the operation proceeds to second process

When it is determined that further repair is unnecessary in second process (1), the operation ends at this point.

When it is determined that further repair is necessary in second process (1), process (2) is further carried out to determine whether further repair is necessary in third process (1), and process (2) is repeatedly carried out until it is determined that further repair is unnecessary.

<Method for Manufacturing Mold>

A method for manufacturing a mold of the invention includes the above-described processes (1) and (2). Another process may be included before or after the processes as necessary. It is preferable to include the above-described processes (1) and (2) as a final process of a process of manufacturing the mold since a mold having stable quality may be manufactured.

Specifically, examples of a method for manufacturing a mold including joining both end portions of a metal band-shaped belt using a known method such as welding to obtain a metal endless belt include the following methods.

(a) Method for obtaining a metal endless belt by joining both end portions of the band-shaped belt after eliminating an irregular defect from the band-shaped belt through processes (1) and (2)

(b) Method for obtaining an endless belt having no irregular defect through processes (1) and (2) from a metal endless belt after obtaining the metal endless belt by joining both end portions of a metal band-shaped belt

(c) Method for manufacturing a mold including obtaining metal plates having no irregular defect through processes (1) and (2) from two metal plates in a planar shape, and then disposing the two metal plates to face each other to install a gasket, and the like as a sealant at an end portion of a gap portion formed by the two metal plates, thereby obtaining the mold

(d) A mold having no irregular defect is manufactured through a process of forming a mold having an irregular defect by putting and pressing a metal plate in a molding and processes (1) and (2) performed on the obtained mold.

### INDUSTRIAL APPLICABILITY

According to a method for repairing a metal plate of the invention, it is possible to quantify a repair amount of an irregular defect on a surface of a metal plate, and to repair an irregular defect at an appropriate repair amount irrespective of the presence or absence of a repair person. In addition, according to a method for repairing a metal plate of the invention, when the metal plate is used as a mold for manufacturing a resin molded body, it is possible to accurately repair an irregular defect on a surface of the metal plate without verification through an obtained resin molded body.

1: A method for repairing an irregular defect present on a surface of a metal plate,
comprising repeating processes (1) and (2) until it is determined that repair of the irregular defect on the surface of the metal plate is unnecessary in the process (1):
process (1): applying light onto the surface of the metal plate, detecting a position of the irregular defect on the surface of the metal plate based on a brightness distribution of the metal plate obtained from reflected light, and quantifying an intensity of brightness of the irregular defect, and
process (2): repairing the irregular defect determined to require repair in the process (1).

2: The method according to claim 1,
wherein the brightness distribution of the metal plate is obtained by converting a brightness distribution of a reflected image or a brightness distribution of a reflected projection image obtained in a detection method wherein:
light is incident on a region including the irregular defect present on the surface of the metal plate and a normal part around the irregular defect from a light source, a reflected image or a reflected projection image of reflected light reflected on the surface of the metal plate is photographed, brightness of the obtained image of the metal plate is measured, and a brightness distribution of the obtained reflected image or a brightness distribution of the obtained reflected projection image is converted into the brightness distribution of the metal plate.

3: The method according to claim 1, wherein light is incident on the surface of the metal plate from at least two directions in the process (1).

4: The method according to claim 1, wherein an angle at which light is incident on the surface of the metal plate is in a range of 20° to 70°.

5: The method according to claim 1,
wherein a part determined to require repair of the irregular defect in the process (1) is a part indicating a peak satisfying at least one of conditions (i) and (ii) among peaks of the brightness distribution of the metal plate:
(i) a height or a depth of a peak of the brightness distribution is greater than or equal to a predetermined value a, and
(ii) a width of a peak at a brightness value, at which a difference between an average value of brightness values of a normal part and a brightness value of a peak of a brightness distribution of an irregular defect portion is a predetermined value b, is greater than or equal to a predetermined value c.

6: The method according to claim 2,
wherein a part determined to require repair of the irregular defect in the process (1) is a part indicating a peak satisfying at least one of conditions (i′) and (ii) among peaks of the brightness distribution of the metal plate:
(i′) Michelson contrast (MC) calculated by Equation (1) below is greater than or equal to a predetermined value d,
MC=(Lₘₐₓ−Lₘᵢₙ)/(Lₘₐₓ+Lₘᵢₙ) (1)
wherein in the case of a concave defect, Lₘₐₓ represents a maximum brightness value of a convex peak, and Lₘᵢₙ represents an average value of brightness values of the normal part, and in the case of a convex defect, Lₘₐₓ represents an average value of brightness values of the normal part, and Lₘᵢₙ represents a minimum brightness value of a concave peak, and
(ii) a width of a peak at a brightness value, at which a difference between an average value of brightness values of a normal part and a brightness value of a peak of a brightness distribution of an irregular defect portion is a predetermined value b, is greater than or equal to a predetermined value c.

7: The method according to claim 5,
wherein the part determined to require repair of the irregular defect is detected by converting the brightness distribution of the metal plate into an angle change rate distribution of the metal plate, and
replacing a peak in the obtained angle change rate distribution of the metal plate with the peak of the brightness distribution of the metal plate in the process (1).

8: The method according to claim 5,
wherein the part determined to require repair of the irregular defect is detected by converting the brightness distribution of the metal plate into an angle change rate distribution of the metal plate, converting the angle change rate distribution of the metal plate into a height distribution of a shape of the metal plate, and
replacing a peak in the obtained height distribution of the shape of the metal plate with the peak of the brightness distribution of the metal plate in the process (1).

9: The method according to claim 5,
wherein the metal plate is a mold configured for molding a resin molded body, and the part determined to require repair of the irregular defect is detected by converting the brightness distribution of the metal plate into an angle change rate distribution of the metal plate, inverting and converting the angle change rate distribution of the metal plate into an angle change rate distribution of a virtual resin molded body, and
replacing a peak in the obtained angle change rate distribution of the virtual resin molded body with the peak of the brightness distribution of the metal plate in the process (1).

10: The method according to claim 5,
wherein the metal plate is a mold configured for molding a resin molded body, and the part determined to require repair of the irregular defect is detected by converting the brightness distribution of the metal plate into an angle change rate distribution of the metal plate, inverting and converting the angle change rate distribution of the metal plate into an angle change rate distribution of a virtual resin molded body, converting the angle change rate distribution of the virtual resin molded body into a brightness distribution of the virtual resin molded body, and
replacing a peak in the obtained brightness distribution of the virtual resin molded body with the peak of the brightness distribution of the metal plate in the process (1).

11: The method for repairing the metal plate according to claim 6,
wherein the metal plate is a mold configured for molding a resin molded body, and a part determined to require repair of the irregular defect is detected by inverting and converting an angle change rate distribution of the metal plate obtained from the brightness distribution of the metal plate into an angle change rate distribution of a virtual resin molded body, converting the angle change rate distribution of the virtual resin molded body into a brightness distribution of the virtual resin molded body, and
replacing a peak in the obtained brightness distribution of the virtual resin molded body with a peak of the brightness distribution of the metal plate in the process (1).

12: The method according to claim 5,
wherein the metal plate is a mold configured for molding a resin molded body, and the part determined to require repair of the irregular defect is detected by converting the brightness distribution of the metal plate into an angle change rate distribution of the metal plate, converting the angle change rate distribution of the metal plate into a height distribution of a shape of the metal plate, inverting and converting the obtained height distribution of the shape of the metal plate into a height distribution of a shape of a virtual resin molded body, and
replacing a peak in the obtained height distribution of the shape of the virtual resin molded body with the peak of the brightness distribution of the metal plate in the process (1).

13: The method according to claim 5,
wherein further repair is determined to be unnecessary when the part determined to require repair of the irregular defect is not detected,
in a process of determining whether repair of the irregular defect of the metal plate is necessary in the process (1).

14: The method according to claim 5,
wherein a value obtained by converting the height or the depth of the peak of the brightness distribution of the metal plate in the condition (i) into shape data is set to shape data X, a value obtained by converting the predetermined value a into shape data is set to shape data Y, and
a required repair amount of the repair is set to |X−Y| or more and |X| or less.

15: The method according to claim 14, wherein the required repair amount of the repair is set to |X−Y| or more and |X| or less by replacing the brightness distribution of the metal plate with any one of
an angle change rate distribution of the metal plate,
a height distribution of the shape of the metal plate,
an angle change rate distribution of a virtual resin molded body,
a brightness distribution of a virtual resin molded body, or
a height distribution of the shape of a virtual resin molded body.

16: The method according to claim 6,
wherein a value obtained by converting a value of Michelson contrast (MC) of a peak of the brightness distribution of the metal plate in the condition (i′) into shape data is set to shape data X,
a value obtained by converting the predetermined value d into shape data is set to shape data Y, and
a required repair amount of the repair is set to |X−Y| or more and |X| or less.

17: The method according to claim 16,
wherein the brightness distribution of the metal plate is replaced with a brightness distribution of a virtual resin molded body, and
the required repair amount of the repair is set to |X−Y| or more and |X| or less.

18: The method according to claim 5,
wherein at the peak of the brightness distribution of the metal plate in the condition (ii),
the width of the peak at the brightness value, at which the difference between the average value of the brightness values of the normal part and the brightness value of the peak of the brightness distribution of the irregular defect portion, is the predetermined value b, is set to V,
the predetermined value c is set to W, and
a required repair amount of the repair is set to |V−W| or more and |V| or less.

19: The method according to claim 18, wherein the required repair amount of the repair is set to |V−W| or more and |V| or less by replacing the brightness distribution of the metal plate with any one of
an angle change rate distribution of the metal plate,
a height distribution of the shape of the metal plate,
an angle change rate distribution of a virtual resin molded body,
a brightness distribution of a virtual resin molded body, or
a height distribution of the shape of a virtual resin molded body.

20: The method according to claim 1, wherein the process (2) comprises at least one operation selected from the group consisting of plastic working and grinding.

21: A method for manufacturing a mold, comprising the method according to claim 1.

22: The method according to claim 2, wherein light is incident on the surface of the metal plate from at least two directions in the process (1).

23: The method according to claim 2,
wherein a part determined to require repair of the irregular defect in the process (1) is a part indicating a peak satisfying at least one of conditions (i) and (ii) among peaks of the brightness distribution of the metal plate:
(i) a height or a depth of a peak of the brightness distribution is greater than or equal to a predetermined value a, and
(ii) a width of a peak at a brightness value, at which a difference between an average value of brightness values of a normal part and a brightness value of a peak of a brightness distribution of an irregular defect portion is a predetermined value b, is greater than or equal to a predetermined value c.
